(19) United States
(12) Patent Application Publication
(10) Pub. No.: US 2025/0184920 A1
(43) Pub. Date: Jun. 5, 2025

(54) MAXIMUM OUTPUT POWER OF A COMMUNICATION DEVICE

(71) Applicant: Telefonaktiebolaget LM Ericsson (publ), Stockholm (SE)

(72) Inventors: Olof LIBERG, Enskede (SE); Yi-Pin Eric WANG, Fremont, CA (US); Andreas HÖGLUND, Solna (SE); Johan BERGMAN, Stockholm (SE); Emre YAVUZ, Stockholm (SE)

(21) Appl. No.: 18/841,117

(22) PCT Filed: Mar. 1, 2023
(86) PCT No.: PCT/EP2023/055105

§ 371 Date: Aug. 23, 2024

Related U.S. Application Data
(60) Provisional application No. 63/315,516, filed on Mar. 1, 2022.

(51) Int. Cl. H04W 52/36; H02J 7/00; H04W 52/02

(52) U.S. Cl. CPC H04W 52/367; H02J 7/007182; H04W 52/0261; H04W 52/365

(57) ABSTRACT

A communication device is configured for use in a communication network. The communication device is configured to set a maximum output power based on a metric reflecting an amount of energy stored in an energy storage of the communication device, e.g., an amount of harvested energy stored in a supercapacitor. The communication device is also configured to perform one or more transmissions according to the maximum output power.

### TECHNICAL FIELD

The present application relates generally to a communication device, and relates more particularly to a maximum output power of such a communication device.

### BACKGROUND

Different types of communication devices may be classified into different so-called power classes, e.g., where different power classes may be defined for fixed wireless access user equipment (UE), vehicular UE, handheld UE, and high power non-handheld UE. The power class of a communication device defines the maximum output power radiated by the communication device, e.g., for any transmission bandwidth within the channel bandwidth during a period of measurement (at least one subframe). The maximum output power defined by the communication device's power class may be referred to as the nominal maximum output power.

A communication device may reduce its maximum output power for various reasons, such as modulation orders, transmit bandwidth configurations, waveform types, narrow allocations, etc. Such maximum output power reduction is referred to as maximum power reduction (MPR). In addition to MPR, a communication device may apply additional MPR (A-MPR) in order to meet additional requirements, additional emission requirements imposed by a regional regulatory organization. Furthermore, a communication device may apply MPR in order to meet requirements for limiting the radio frequency (RF) exposure to humans, e.g., for meeting Specific Absorption Rate (SAR) limits. This MPR is generically referred to as a power management MPR (P-MPR).

Despite existing approaches to maximum output power reduction, there remains a need for further improvements to maximum output power reduction.

### SUMMARY

Some embodiments herein facilitate a communication device setting its maximum output power based on the amount of energy it has stored in an energy storage of the device. For example, some embodiments allow a communication device to reduce its maximum output power as needed to account for reductions over time in the amount of energy that the device has stored in its energy storage. These embodiments for maximum output power reduction may prove advantageous for a communication device that harvests energy and/or stores energy in a super capacitor, e.g., because the embodiments account for the fact that the device in this case may have a shortage of stored energy and may correspondingly not be able to guarantee a constant maximum output power matching its declared power class for the length of a full connection. These and other embodiments may correspondingly enable a communication device to reduce its maximum output power when stored energy diminishes, in order to prolong the time the communication device can remain operational and/or maintain an established connection with the network.

Alternatively or additionally, some embodiments herein define a power class for communication devices capable of setting and/or reducing maximum output power based on the amount of energy stored in an energy storage. A communication device may accordingly transmit signaling to the communication network indicating whether the communication device belongs to such a power class. The communication network may correspondingly exploit this signaling for scheduling purposes. For example, in some embodiments, the communication network may make a scheduling decision for a communication device based on whether the device belongs to the power class.

More particularly, embodiments herein include a method performed by a communication device configured for use in a communication network. The method comprises setting a maximum output power based on a metric reflecting an amount of energy stored in an energy storage of the communication device. The method also comprises performing one or more transmissions according to the maximum output power.

In some embodiments, the amount of energy comprises the amount of harvested energy and/or the energy storage of the communication device is a super capacitor.

In some embodiments, setting the maximum output power comprises, during a connection with the communication network, setting the maximum output power also based on an expected length of the connection with communication network. In one such embodiment, setting the maximum output power comprises, during the connection with the communication network, reducing the maximum output power as needed to maintain the connection with the communication network for at least the expected length.

In some embodiments, setting the maximum output power comprises setting the maximum output power to be within a maximum value and a minimum value, subject to a tolerance. In one embodiment, a magnitude of deviation tolerated below the minimum value is different than a magnitude of deviation tolerated above the maximum value.

In some embodiments, the maximum output power is a maximum output power at an antenna connector of the communication device. In one such embodiment, setting the maximum output power comprises setting the maximum output power such that: a corresponding measured peak equivalent isotropic radiated power, EIRP, is within specified EIRP bounds; and/or a corresponding measured total radiated power, TRP, is within specified TRP bounds.

In some embodiments, the metric is the amount of energy stored in the energy storage. In other embodiments, the metric is a voltage associated with the energy storage, wherein the voltage is a voltage of the energy storage in relation to a cutoff voltage, wherein the cutoff voltage is a voltage level below which the energy storage is considered discharged.

In some embodiments, the communication device belongs to a class of communication devices capable of setting or reducing maximum output power based on an amount of energy stored in an energy storage at the communication device. In this case, the method may further comprise reporting, to the communication network, that the communication device belongs to the class of communication devices.

In some embodiments, said setting is performed as part of adapting, over time, the maximum output power based on the metric as the amount of energy stored in the energy storage varies. In one such embodiment, said adapting comprises reducing the maximum output power when the metric reflects that the amount of energy stored in the energy storage has fallen below a threshold.

In some embodiments, the method further comprises calculating a power headroom based on the maximum output power and/or based on a maximum value that bounds the maximum output power. The method may also comprise reporting the power headroom to the communication network.

In some embodiments, the method further comprises transmitting, to the communication network, signaling indicating that the communication device is capable of setting or reducing the maximum output power based on the amount of energy stored in the energy storage at the communication device.

Other embodiments herein include a method performed by a network node configured for use in a communication network. The method comprises receiving, from a communication device, signaling indicating that the communication device is capable of setting or reducing maximum output power based on an amount of energy stored in an energy storage at the communication device.

In some embodiments, the amount of energy comprises the amount of harvested energy and/or the energy storage of the communication device is a super capacitor.

In some embodiments, the signaling indicates that the communication device is capable of setting or reducing maximum output power also based on an expected length of a connected with communication network.

In some embodiments, the signaling indicates that the communication device is capable of setting the maximum output power to be within a maximum value and a minimum value, subject to a tolerance, based on the amount of energy stored in the energy storage at the communication device. In one embodiment, a magnitude of deviation tolerated below the minimum value is different than a magnitude of deviation tolerated above the maximum value.

In some embodiments, the maximum output power is a maximum output power at an antenna connector of the communication device. In one embodiment, the signaling indicates that the communication device is capable of setting the maximum output power such that: a corresponding measured peak equivalent isotropic radiated power, EIRP, is within specified EIRP bounds; and/or a corresponding measured total radiated power, TRP, is within specified TRP bounds.

In some embodiments, the metric is the amount of energy stored in the energy storage. In other embodiments, the metric is a voltage associated with the energy storage, wherein the voltage is a voltage of the energy storage in relation to a cutoff voltage, wherein the cutoff voltage is a voltage level below which the energy storage is considered discharged.

In some embodiments, the signaling indicates that the communication device is capable of setting or reducing maximum output power based on an amount of energy stored in an energy storage at the communication device by indicating that the communication device belongs to a class of communication devices capable of setting or reducing maximum output power based on an amount of energy stored in an energy storage at the communication device.

In some embodiments, the signaling indicates that the communication device is capable of adapting, over time, the maximum output power based on the metric as the amount of energy stored in the energy storage varies. In this case, the method may further comprise receiving, from the communication device, signaling indicating changes in the maximum output power.

In some embodiments, the method further comprises receiving, from the communication device, a reporting of a power headroom of the communication device that is calculated based on the maximum output power and/or based on a maximum value that bounds the maximum output power.

In some embodiments, comprising making a scheduling decision based on the signaling.

In one embodiment, the method further comprises determining, from the signaling, information about energy storage at the communication device. In this case, the scheduling decision may be made based on the determined information. In these and other embodiments, the scheduling decision may include: (i) a decision of a modulation and coding scheme, MCS, for an uplink transmission; (ii) a decision of an offset K2 between a downlink slot where a downlink control channel carrying downlink control information for uplink scheduling is received and an uplink slot where an uplink data transmission is to be sent on an uplink shared data channel; (iii) a decision of a frequency bandwidth of an uplink shared data channel for an uplink data transmission; (iv) a decision of a transport block size, TBS, of an uplink transmission; (v) a decision of a type of information to transmit in an uplink transmission; (vi) a decision of whether and/or when a communication device is to perform an uplink transmission; (vii) a decision of which communication device is to perform an uplink transmission; and/or (viii) a decision of a format of an uplink transmission.

In some embodiments, the information about energy storage at the communication device includes: (i) an energy harvesting rate of the communication device relative to energy consumption of the communication device; (ii) an amount of energy stored in the energy storage; (iii) a rate of energy consumption of the communication device; (iv) whether the amount of energy stored in the energy storage is less than a threshold; and/or (v) a prediction of how a maximum output power of the communication device will change during a connection or signaling exchange with the communication network.

Other embodiments herein include corresponding apparatus, computer programs, and carriers of those computer programs. For example, embodiments herein include a communication device configured for use in a communication network. The communication device is configured to set a maximum output power based on a metric reflecting an amount of energy stored in an energy storage of the communication device. The communication device is also configured to perform one or more transmissions according to the maximum output power.

Embodiments herein further include a network node configured for use in a communication network. The network node is configured to receive, from a communication device, signaling indicating that the communication device is capable of setting or reducing maximum output power based on an amount of energy stored in an energy storage at the communication device.

### BRIEF DESCRIPTION OF THE DRAWINGS

FIG. 1 is a block diagram of a communication network in accordance with some embodiments

FIG. 2A is a logic flow diagram of a method performed by a communication device according to some embodiments.

FIG. 2B is a logic flow diagram of a method performed by a communication device according to other embodiments.

FIG. 2C is a logic flow diagram of a method performed by a communication device according to still other embodiments.

FIG. 2D is a logic flow diagram of a method performed by a communication device according to yet other embodiments.

FIG. 2E is a logic flow diagram of a method performed by a communication device according to further embodiments.

FIG. 2E is a logic flow diagram of a method performed by a communication device according to further embodiments.

FIG. 2F is a logic flow diagram of a method performed by a communication device according to further embodiments.

FIG. 3A is a logic flow diagram of a method performed by a network node according to some embodiments.

FIG. 3B is a logic flow diagram of a method performed by a network node according to other embodiments.

FIG. 3C is a logic flow diagram of a method performed by a network node according to yet other embodiments.

FIG. 4 is a block diagram of a communication device according to some embodiments.

FIG. 5 is a block diagram of a network node according to some embodiments.

FIG. 6 is a block diagram of a communication system in accordance with some embodiments

FIG. 7 is a block diagram of a user equipment according to some embodiments.

FIG. 8 is a block diagram of a network node according to some embodiments.

FIG. 9 is a block diagram of a host according to some embodiments.

FIG. 10 is a block diagram of a virtualization environment according to some embodiments.

FIG. 11 is a block diagram of a host communicating via a network node with a UE over a partially wireless connection in accordance with some embodiments.

### DETAILED DESCRIPTION

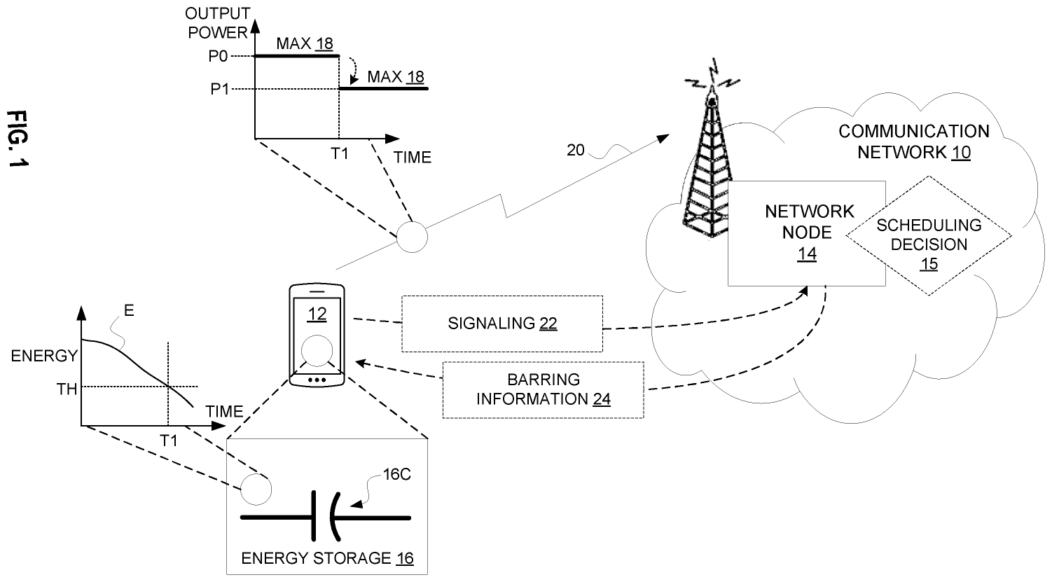

FIG. 1 shows a communication device 12 configured for use in a communication network 10 according to some embodiments, e.g., where the communication device 12 may be a compact internet-of-things (IoT) device. The communication network 10 in this regard includes a network node 14, e.g., a radio network node, configured to provide communication service to the communication device 12.

The communication device 12 as shown stores energy in an energy storage 16. In one embodiment, the energy storage 16 is a battery. In another embodiment, as shown, the energy storage 16 is a supercapacitor 16C, e.g., that can be recharged a more or less unlimited number of times but has a limited energy density. As shown in FIG. 1, for example, the amount E of energy stored in the energy storage 16 may diminish over time. In the example of FIG. 1, for instance, the amount E of energy stored falls below a threshold TH at time T1.

No matter the particular nature of the energy storage 16, the energy that the communication device 12 stores in the energy storage 16 may be harvested, at least in part, by the commination device 12, e.g., from light, heat vibrations, and/or electro-magnetic waves. In these and other embodiments, the communication device 12 may be constrained and limited in the energy it can provide to its modem over time, and/or may not be able to guarantee a constant maximum output power matching its declared power class for the length of a full connection due to a shortage of stored energy.

As shown in FIG. 1, for example, the communication device 12 sets a maximum output power 18, e.g., a maximum output power at an antenna connector of the communication device 12. This maximum output power 18 governs the maximum power for one or more transmissions 20, e.g., uplink transmission(s) to the communication network 10.

The communication device 12 may set the maximum output power 18 to be within a maximum value and a minimum value, subject to some tolerance for deviation therefrom. In these and other embodiments, the communication device 12 may set the maximum output power 18 based on, or as a function of, a class of communication devices to which the communication device 12 belongs, e.g., a power class of the communication device 12.

Diminishing amounts of energy stored in the energy storage 16, though, may jeopardize the ability of the communication device 12 to provide this maximum output power 18 for the length of a full connection with the communication network 10, e.g., a full radio resource control (RRC) connection. In the example of FIG. 1, for instance, if the communication device 12 sets the maximum output power 18 to P0 before time T1, when the amount E of energy stored in the energy storage 18 drops below the threshold TH at time T1, the communication device 12 may no longer be able to provide a maximum output power 18 of P0 (or at least guarantee P0 for the length of a full connection). In some embodiments, then, the amount E of energy stored in the energy storage 16 has an impact on a maximum output power 18 of the communication device 12 and/or an impact on a power class of the communication device 12.

Some embodiments herein accordingly facilitate the communication device 12 setting its maximum output power 18 based on the amount E of energy it has stored in the energy storage 16. For example, some embodiments allow the communication device 12 to reduce its maximum output power 18 (e.g., from level P0 to level P1) as needed to account for reductions over time in the amount E of energy that the communication device 12 has stored in its energy storage 16. These embodiments for maximum output power reduction may prove advantageous for a communication device 12 that harvests energy and/or stores energy in a super capacitor 16C, e.g., because the embodiments account for the fact that the device 12 in this case may have a shortage of stored energy and may correspondingly not be able to guarantee a constant maximum output power matching its declared power class for the length of a full connection. These and other embodiments may correspondingly enable the communication device 12 to reduce its maximum output power 18 when stored energy diminishes, in order to prolong the time the communication device 12 can remain operational and/or maintain an established connection with the communication network 10.

More particularly, the communication device 12 according to some embodiments herein obtains a metric reflecting the amount E of energy stored in the energy storage 16. The metric may be the amount E of energy itself. Or, the metric may be a voltage associated with the energy storage 16, e.g., a voltage of the energy storage 16 in relation to a cutoff voltage, wherein the cutoff voltage is a voltage level below which the energy storage 16 is considered discharged.

In any event, the communication device 12 according to some embodiments sets the maximum output power 18 based on this metric reflecting the amount E of energy stored in the energy storage 16. In some embodiments, the communication device 12 sets the maximum output power 18 also based on an expected length of a connection with the communication network 10. In fact, in some embodiments, the communication device 12 sets the maximum output power 18 in this way as part of adapting, over time, the maximum output power 18 based on the metric as the amount E of energy stored in the energy storage 16 varies. As shown in the example of FIG. 1, this may involve reducing the maximum output power 18 as the amount E of energy stored in the energy storage 16 decreases. For example, the communication device 12 may reduce the maximum output power 18 from level P1 to level P0 when the metric reflects that the amount E of energy stored in the energy storage 16 has fallen below a threshold TH. With a reduced maximum output power 18, the communication device 12 may be able to maintain a connection with the communication network 10 for longer than if the communication device 12 had continued to operate with a larger maximum output power 18.

In some embodiments, the communication device 12 transmits signaling 22 indicating that the communication device 12 is capable of setting or reducing maximum output power 18 based on an amount E of energy stored in an energy storage 16 at the communication device 12. The signaling 22 may for instance be capability signaling, e.g., that conveys one or more other capabilities of the communication device 12 as well. In other embodiments, by contrast, the signaling 22 indicates that the communication device 12 is capable of setting or reducing maximum output power 18 based on an amount E of energy stored in an energy storage 16 by indicating that the communication device 12 belongs to a certain class of communication devices. This class may for instance be identified as a power class, e.g., a so-called flexible power class.

In some embodiments, the network node 14 makes a scheduling decision 15 based on this signaling 22. For example, the scheduling decision 15 may include a decision of a modulation and coding scheme, MCS, for an uplink transmission. The scheduling decision 15 may alternatively or additionally include a decision of an offset K2 between a downlink slot where a downlink control channel carrying downlink control information for uplink scheduling is received and an uplink slot where an uplink data transmission is to be sent on an uplink shared data channel. Or, the scheduling decision 15 may include a decision of a frequency bandwidth of an uplink shared data channel for an uplink data transmission, a decision of a transport block size, TBS, of an uplink transmission, and/or a decision of a type of information to transmit in an uplink transmission. In other embodiments, the scheduling decision 15 may alternatively or additionally include a decision of whether and/or when a communication device is to perform an uplink transmission, a decision of which communication device is to perform an uplink transmission, and/or a decision of a format of an uplink transmission.

For example, the network node 14 may determine, from the signaling 22, information about energy storage at the communication device 12. This information may, for example, include an amount of energy stored in the energy storage 16, a rate of energy consumption of the communication device 12, and/or whether the amount of energy stored in the energy storage 16 is less than a threshold TH. Alternatively or additionally, the information may include an energy harvesting rate of the communication device 21 relative to energy consumption of the communication device 12 and/or a prediction of how a maximum output power of the communication device 12 will change during a connection or signaling exchange with the communication network 10. Regardless, the communication device 12 may then make the scheduling decision 15 based on the determined information.

Alternatively or additionally, in some embodiments, the network node 14 transmits barring information 24 for the class of communication devices, e.g., capable of setting or reducing maximum output power 18 based on an amount E of energy stored in an energy storage 16 at the communication device 12. In some embodiments, the barring information 24 indicates whether the class is barred from access to the communication network 10. In this case, the communication device 12 may access or refrain from accessing the communication network 10 depending on whether the communication device 12 is barred according to the barring information 24.

Alternatively or additionally, the barring information 24 indicates that the class is allowed access to the communication network 10 provided that maximum output power does not fall below a minimum value. In this case, the communication device 12 may access the communication network 10 and set the maximum output power 18 to not fall below the minimum value.

Some embodiments herein are applicable in the following example context, where the communication device 12 is exemplified as a user equipment (UE), the communication network 10 is exemplified as being a 3^{rd} Generation Partnership Project (3GPP) network such as a 5G network, and the network node 14 is exemplified as a gNB. In some embodiments, the energy storage of the communication device 12 is exemplified as a supercapacitor.

Some embodiments herein are applicable in a communication network specified by 3GPP, e.g., a Long-Term Evolution (LTE) network, a 5G network, etc. In these and other embodiments, embodiments herein may be applicable for facilitating energy harvesting applications (see, e.g., 3GPP S1-214135) and/or ultra-low power UEs.

The communication device 12 according to some embodiments herein can harvest energy from any sort of source, including indoor and outdoor light, heat, vibrations and electro-magnetic waves. The amount of power harvested for cellular applications is usually rather limited, though, e.g., a photovoltaic cell may harvest 244 uW. By contrast, a typical 3GPP device operates using 23 dBm, i.e., 200 mW, output power. The 3GPP specification supports also other power classes including 14 dBm (25 mW). Future power classes may even be specified to support operation using less power, e.g., closer to the amount of power harvestable.

In some embodiments, such as where the communication device 12 is 5G NR UE, the communication device 12 may be expected to provide a nominal output power according to its power class. It is however allowed to reduce the output power e.g., to ensure “compliance with applicable electromagnetic energy absorption requirements and addressing unwanted emissions” (See TS 38.101-1 V16.0.0).

In case of the UE power classes defined for the high frequency bands in frequency range 2 (FR2), TS 38.101-2 V16.0.0 specifies not only a maximum output power level but also other characteristics requirements related to the antenna diagram which in turn is related to antenna configuration aspects such as number of antenna panels and number of antenna elements per antenna panel. Examples of such requirements are the total radiated power and minimum peak EIRP which depends on the power feed into the antennas and the antenna configuration.

In some embodiments, a UE's actual output power is regulated by a power control that is using power control commands signaled by the serving base station (BS), e.g., exemplifying the network node 14 in FIG. 1. To inform the BS about the available power budget, the UE sends power headroom reports (PHR) to the communication network 10. These contain the difference between the maximum available power and the actual used power. A PHR report can be triggered e.g., periodically, or when the measured pathloss changes by more than a threshold, or when the power reduction required to comply with “applicable electromagnetic energy absorption requirements and addressing unwanted emissions” (See TS 38.101-1 V16.0.0) exceeds a threshold. The communication network 10 may use the PHR information for determining how to configure the radio link, and schedule the UE, including the used UE output power, modulation and coding scheme (MCS), and transmit bandwidth selection.

In some embodiments, before accessing a cell, a UE needs to evaluate the suitability of the cell. One of the steps in this procedure is to check the cell selection criterion (See TS 38.304 V16.0.0). The UE evaluates the uplink coverage provided by a cell based on UE received power measurements and the UE maximum output power according to its power class capability. The UE compares the estimated coverage according to its supported power class with a coverage threshold configured by the network. If the estimated coverage exceeds the threshold, then the cell is assumed to be suitable for camping.

Before performing an actual access, the UE also needs to check that the cell is not barred. Cell barring is indicated as part of the broadcasted system information and informs the UE if the cell can be camped on or not.

Some embodiments herein address certain challenge(s) in this context. Some embodiments herein are applicable for compact internet-of-things (IoT) devices that, due to form factor constraints, support limited power storage. If the device is also relying on power harvesting, the accumulated charge stored in a battery or super capacitor may be even more constrained and limited in the power and current it can provide to the IoT wireless modem over time. This implies that such a device may not be able to guarantee a constant maximum output power matching its declared power class for the length of a full connection due to a shortage of stored energy.

In this context, some embodiments herein allow a UE to reduce its maximum output power to prolong the time it is operational and e.g., maintain an established RRC connection.

Some embodiments in this regard introduce adaptations of the 3GPP radio access network (RAN) protocol stack to support the introduction of a flexible UE power class that allows a UE to flexibly reduce its maximum output power before and/or during a connection to facilitate operation on limited energy. In particular, some embodiments introduce a flexible UE power class that allows a UE to reduce and increase its supported maximum output power depending on the amount of available energy in its energy storage. Some embodiments may thereby advantageously reduce the requirements on UE energy storage and/or facilitate operation on harvested energy stored in a super capacitor.

### Flexible UE Power Class

In a first embodiment, a flexible UE power class is introduced, e.g., so as to be defined according the 3GPP specifications. The flexible UE power class supports a flexible maximum output power level that in parts is defined by a configured maximum power level P_{maxflex}. In this case, the maximum output power 18 herein is exemplified by P_{maxflex}. P_{maxflex} can be reconfigured, i.e., reduced or increased, even during an RRC connection. P_{maxflex} can further be restricted to belong to a range of maximum output power levels. The range may be defined by a maximum P_{maxflex,max} and a minimum level P_{maxflex,min}, i.e. P_{maxflex}ϵ[P_{maxflex,min}, P_{maxflex,max}]. P_{maxflex}, P_{maxflex,min}, P_{maxflex,max} are defined at the antenna connector and is referred to as conducted power.

In one implementation, P_{CMAX,f,c}=P_{maxflex} and the limits within which P_{CMAX,f,c} can change are as shown below.

$${P}_{CMAX \_ L , f , c} \leq {P}_{CMAX , f , c} \leq {P}_{CMAX \_ H , f , c} with$$

$${P}_{CMAX \_ L , f , c} = MIN \{ {P}_{EMAX , c} - Δ {T}_{C , c} , ( {P}_{P o w e r C l a s s} - Δ {P}_{P o w e r C l a s s} ) - MAX ( MAX ( MP {R}_{c} + Δ M P {R}_{c} , A - {MPR}_{c} ) + Δ {T}_{IB , c} + Δ {T}_{C , c} + Δ {T}_{R x S R S} , P - MP {R}_{c} ) , {P}_{maxflex , min} \}$$

$${P}_{CMAX \_ H , f , c} = MIN \{ {P}_{EMAX , c} , {P}_{PowerClass} - Δ {P}_{P o w e r C l a s s} , {P}_{maxflex , max} \}$$

Here, P_{maxflex,min} represents a minimum value specified for the maximum output power P_{maxflex} and P_{maxflex,max} represents a maximum value specified for the maximum output power P_{maxflex}.

Note, though, that in some embodiments some variation from the maximum output power P_{maxflex} is tolerated in practice. For example, tolerances within which the UE may adapt its maximum output power even during RRC Connected may depend on various aspects such as the used modulation. Generally, then, some embodiments may effectively introduce new tolerances making the configured max power level even more flexible to facilitate usage of a limited power source that may vary in its energy level. In fact, some embodiments herein supplement the UE power classes that are defined in TS 38. 101 section 6.2.1 to fixed levels with some tolerances (eg PC3=23 dBm±2 dB). In particular, some embodiments update the UE Power Class table to indicate this flexible power class. See an example implementation in the below table, where the tolerance is used to facilitate the flexibility. The difference compared to other power classes is that a large reduction is allowed.

TABLE 6.2.1-1
UE Power Class

| | | | | | | | | |
|---|---|---|---|---|---|---|---|---|
| NR | Class 1 | Tolerance | Class 2 | Tolerance | Class 3 | Tolerance | Class Flex | Tolerance |
| band | (dBm) | (dB) | (dBm) | (dB) | (dBm) | (dB) | (dBm) | (dB) |

| | | | | |
|---|---|---|---|---|
| n1 | 23 | ±2 | 23 | +2/−23 |

Other embodiments herein are implemented as shown in the table below:

TABLE 6.2.1-1
UE Power Class

| | | | | | | | | |
|---|---|---|---|---|---|---|---|---|
| NR | Class 1 | Tolerance | Class 2 | Tolerance | Class 3 | Tolerance | Class Flex | Tolerance |
| band | (dBm) | (dB) | (dBm) | (dB) | (dBm) | (dB) | (dBm) | (dB) |

| | | | | |
|---|---|---|---|---|
| n1 | 23 | ±2 | [P_{flex, min}, | ±2 |
| | | | P_{flex, max}] | |

Still other embodiments herein implement the flexile power class as a specific type and/or purpose of MPR. For example, similar to A-MPR or P-MPR, some embodiments allow MPR for conserving energy stored at the UE and/or for prolonging an RRC connection. Or, stated another way, some embodiments allow MPR due to energy shortage at the communication device. As an example, in some embodiments:

the minimum value P_{CMAX_L,f,c} is equal to:

$${P}_{CMAX \_ L , f , c} = MIN \{ {P}_{EMAX , c} - Δ {T}_{C , c} , ( {P}_{P o w e r C l a s s} - Δ {P}_{P o w e r C l a s s} ) - MAX ( MAX ( MP {R}_{c} + Δ M P {R}_{c} , A - {MPR}_{c} ) + Δ {T}_{IB , c} + Δ {T}_{C , c} + Δ {T}_{R x S R S} , P - MP {R}_{c} , F - {MPR}_{c} ) \} ;$$

and
the maximum value P_{CMAX_H,f,c} is equal to:

$${P}_{CMAX \_ H , f , c} = MIN \{ {P}_{EMAX , c} , {P}_{PowerClass} - Δ {P}_{P o w e r C l a s s} \}$$

where F-MPR_{c} is maximum output power reduction due to energy shortage at the communication device.

In some embodiments, beside the flexible maximum output power level, the antenna configuration (e.g., in terms of number of active antenna panels or number of active antenna elements per antenna panel) can also be flexible. This may be particularly suitable for higher frequency bands, such as the frequency bands in FR2 specified in (See TS 38.101-2 version 16.0.0). This, in combination with a flexible conducted power, will lead to flexible capabilities for the Minimum peak EIRP (P_{EIRP}) and Maximum total radiated power (TRP), i.e.:

$${P}_{EIRPflex} ϵ [ {P}_{EIRPflex , min} , {P}_{EIRPflex , max} ] .$$

$$TR {P}_{flex} ϵ [ {TRP}_{flex , min} , TR {P}_{flex , max} ] .$$

More specifically, according to some embodiments, then, the configured UE maximum output power P_{CMAX,f,c} for carrier f of a serving cell c shall be set such that the corresponding measured peak EIRP P_{UMAX,f,c} is within the following bounds:

$$MIN \{ {P}_{EIRPflex , min} , {P}_{P o w e r c l a s s} - MAX ( MAX ( MP {R}_{f , c} , A - MP {R}_{f , c} , ) + Δ {MB}_{P , n} , P - MP {R}_{f , c} ) - MAX \{ T ( MAX ( MP {R}_{f , c} , A - MP {R}_{f , c} , ) ) , T ( P - {MPR}_{f , c} ) \} \} \leq {P}_{UMAX , f , c} \leq MIN \{ {P}_{EIRPflex , max} , {EIRP}_{max} \}$$

while the corresponding measured total radiated power P_{TMAX,f,c} is bounded by:

$${P}_{TMAX , f , c} \leq MIN \{ {TRP}_{EIRPflex , max} , {TRP}_{max} \} .$$

No matter how implemented, in some embodiments the UE adapts the maximum output power as a function of the remaining energy storage, e.g., the battery capacity defined in, e.g., ampere-hours (Ah) or watt-hours (Wh). The measured battery voltage may serve as an indication of the remaining energy storage. The battery voltage in relation to the battery cutoff voltage may serve as a further indication of the remaining energy storage. Here, the cutoff voltage is referred to as the voltage level below which the energy source is considered discharged, and should not deliver further power to the device until recharged.

### UE Reporting Aspects

In one embodiment, the UE is configured to report its flexible power class providing an indication of P_{maxflex}, P_{maxflex,max} and P_{maxflex,min} for FR1 and/or P_{EIRPflex}, P_{EIRPflex,min}, P_{EIRPflex,max}, TRP_{flex}, TRP_{flex,min}, TRP_{flex,max} for FR2. This information can be provided as part of the reported UE capabilities or part of an enhanced PHR. Either way, the reported information exemplifies the signaling 22 in FIG. 1.

The enhanced PHR could also indicate the difference of the used output power to the currently available P_{maxflex} as well as to P_{maxflex,max}.

In one embodiment, the UE is configured to report changes in its flexible maximum output power P_{maxflex} to the network.

In one embodiment, a measurement report from the UE to the network is indicative of the estimated remaining energy stored in the UE's energy storage given the current P_{maxflex}.

In one embodiment, which can be combined with any of the above, characteristics of the UE's super capacitor can be reported as part of the UE capability reporting.

In one embodiment, the UE can report to the network that its energy storage is about to become so depleted that no further communication will be possible before the energy storage has been recharged (e.g., using energy harvesting from the environment). This information may be valuable for operation and maintenance purposes or other purposes. In an alternative embodiment, the UE can report this information when the communication has been resumed after the communications disruption instead of before the disruption.

### Cell Access and Suitability Aspects

In one embodiment, a cell may indicate that UEs supporting a flexible power class are barred from access. Alternatively, the network (NW) may indicate that UEs supporting a flexible power class are allowed to access under the condition that the flexible maximum output power never goes below a configured threshold during a connection, i.e., the NW defines a minimum permitted P_{maxflex,min}.

In one embodiment, the UE should use its minimum level P_{maxflex,min} when evaluating the provided cell coverage level indicator Srxlex according to the cell selection criterion (See TS 38.304 V16.0.0). In detail, TS 38.304 section 5.2.3.2 and the expression P_{compensation} would include P_{maxflex,min} level or P_{maxflex} as exemplified below:

$$Pcompensation = max ( PE MAX 1 - P max flex , 0 )$$

$$Srxlev = Qrxlevmeas - ( Qrxlev min + Qrxlev min offset ) - Pcompensation - Qoffsettemp$$

In one embodiment, a cell may provide a Physical Random Access Channel (PRACH) configuration for UEs that support a flexible power class. The PRACH configuration may indicate dedicated preamble(s) and/or PRACH resources for such UEs to use during random access when establishing a connection or in connected mode when getting back in sync, e.g., after a time alignment timer expires. The dedicated PRACH configuration may in addition to the flexible power class provide an indication for other features that require early identification, i.e., before UE capability information is explicitly signaled to the network. The PRACH configuration for UEs that support a flexible power class may indicate implicitly that the cell is NOT barred for UEs that support flexible power class, i.e., it is barred otherwise.

### Implementation Related Aspects

In one embodiment, the network determines the scheduling decision (e.g., modulation and coding scheme (MCS) and/or K2) for a UE's subsequent uplink transmissions based on one or more maximum output power reports from the UE. Here, K2 is the offset between the downlink (DL) slot where the Physical Downlink Control Channel (PDCCH) carrying downlink control information (DCI) for uplink scheduling is received and the uplink (UL) slot where the UL data need to be sent on the Physical Uplink Shared Channel (PUSCH). For example, based on one or more maximum output power reports from the UE in the past, the network can derive (e.g., through machine learning or artificial intelligence techniques) the energy harvesting rate relative to UE power consumption during uplink transmissions. Such information can be used to incrementally adjust the MCS and/or K2 for one or more subsequent uplink transmissions before the UE provides the next update on its maximum output power.

In one embodiment, the network adjusts the scheduled PUSCH bandwidth for a UE's subsequent uplink transmissions based on one or more maximum output power reports from the UE. For example, the network may infer that the UE's available energy is dwindling down and adopt an energy-efficient scheduling decision for the UE. Although allocating more PUSCH bandwidth (or physical resource blocks, PRBs) for such a UE is not spectrally efficient, it is energy efficient according to Shannon's information theory.

In one embodiment, which can be combined with any of the above, the base station (BS) based on the UE report(s) from the UE predicts how the maximum output power from the UE will change during the signaling exchange and adapts the scheduling of the UE (i.e., Transmit Power Control (TPC), transport block size (TBS), MCS, etc.) to achieve the highest possible data rate per transmission. Since the BS, unlike for a traditional UE, would expect the UE maximum power to reduce for subsequent UL data transmissions, it would provide the UL grant for those taking this in to account, e.g., with more robust scheduling.

In one embodiment, the network can use the information related to the UE's remaining stored energy for a given P_{maxflex} when it determines its scheduling decisions for the UE regarding the scheduled transmission format (e.g., bandwidth and MCS) and/or regarding the type of information that is scheduled (e.g., prioritizing scheduling of the most critical messages or services).

In one embodiment, the BS may predict the expected UE output based on which type of supercapacitor the UE is equipped with, or key parameters for such.

In one embodiment, the above mentioned BS knowledge about the UE's energy storage is at least partially based on an energy storage model which uses machine learning methods to improve over time.

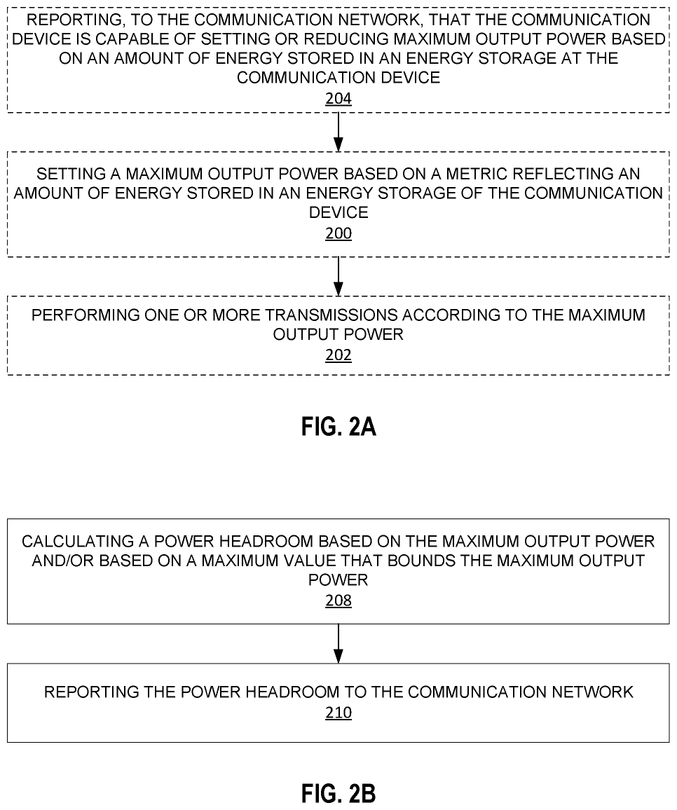

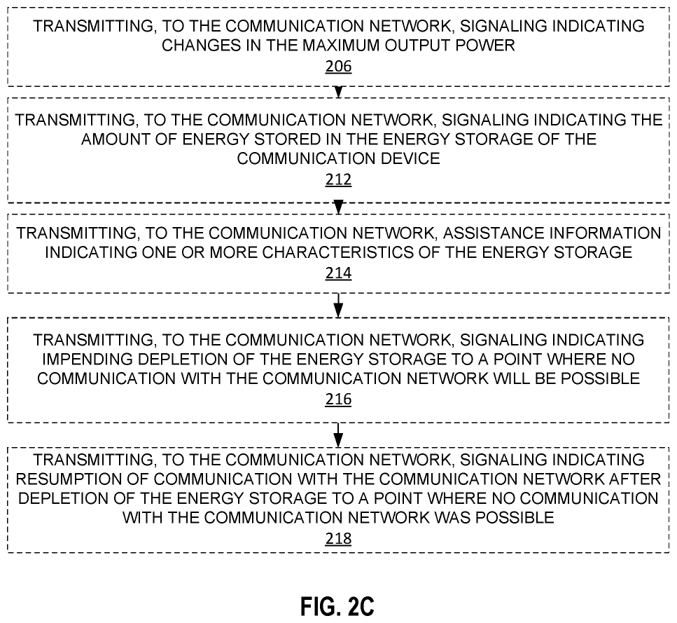

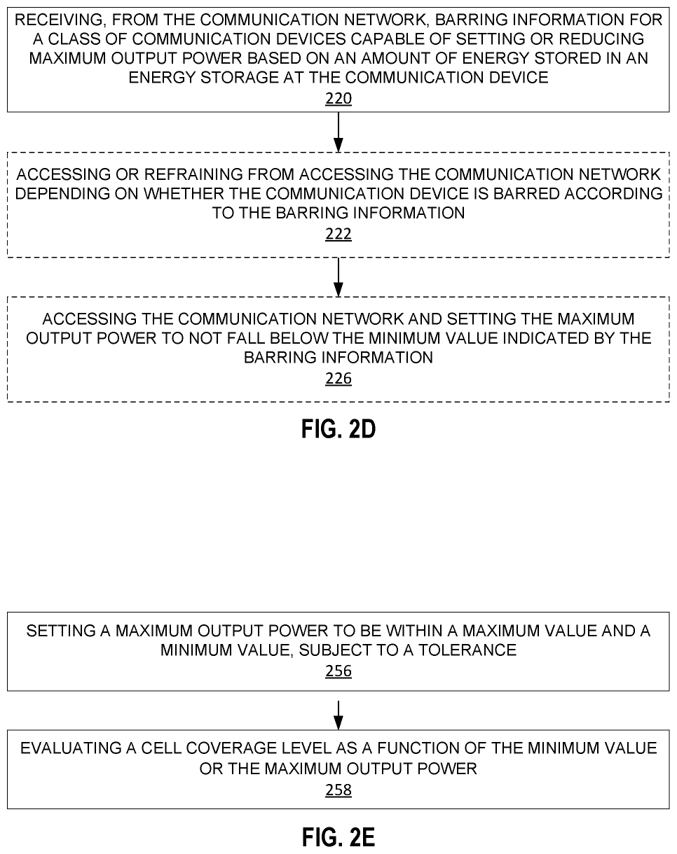

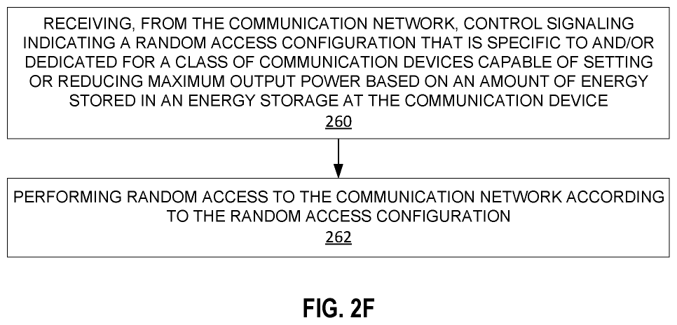

In view of the modifications and variations herein, FIG. 2A depicts a method performed by a communication device 12 configured for use in a communication network 10. The method in some embodiments comprises setting a maximum output power 18 based on a metric reflecting an amount E of energy stored in an energy storage 16 of the communication device 12 (Block 200). The method in these embodiments may comprise performing one or more transmissions 20 according to the maximum output power 18 (Block 202).

Alternatively or additionally, the method in FIG. 2A may comprise transmitting, to the communication network 10, signaling 22 indicating that the communication device 12 is capable of setting or reducing maximum output power 18 based on an amount E of energy stored in an energy storage 16 at the communication device 12 (Block 204). For example, in some embodiments, such signaling 22 indicates that the communication device 12 belongs to a class of communication devices capable of setting or reducing maximum output power 18 based on an amount E of energy stored in an energy storage 16 at the communication device 12.

In some embodiments, the amount E of energy comprises the amount of harvested energy.

In some embodiments, the energy storage 16 of the communication device 12 is a super capacitor 16C.

In some embodiments, setting the maximum output power 18 comprises, during a connection with the communication network 10, setting the maximum output power 18 also based on an expected length of the connection with communication network 10. In some embodiments, setting the maximum output power 18 comprises setting the maximum output power 18 to be within a maximum value and a minimum value, subject to a tolerance. In some embodiments, the minimum value P_{CMAX_L,f,c} is equal to:

$${P}_{CMAX \_ L , f , c} = MIN \{ {P}_{EMAX , c} - Δ {T}_{C , c} , ( {P}_{P o w e r C l a s s} - Δ {P}_{P o w e r C l a s s} ) - MAX ( MAX ( MP {R}_{c} + Δ M P {R}_{c} , A - {MPR}_{c} ) + Δ {T}_{IB , c} + Δ {T}_{C , c} + Δ {T}_{R x S R S} , P - MP {R}_{c} ) , {P}_{maxflex , min} \} ;$$

and
the maximum value P_{CMAX_H,f,c} is equal to:

$${P}_{CMAX \_ H , f , c} = MIN \{ {P}_{EMAX , c} , {P}_{P o w e r C l a s s} - Δ {P}_{P o w e r C l a s s} , {P}_{maxflex , max} \} .$$

In some embodiments, the minimum value P_{CMAX_L,f,c} is equal to:

$${P}_{CMAX \_ L , f , c} = MIN \{ {P}_{EMAX , c} - Δ {T}_{C , c} , ( {P}_{P o w e r C l a s s} - Δ {P}_{P o w e r C l a s s} ) - MAX ( MAX ( MP {R}_{c} + Δ {MPR}_{c} , A - {MPR}_{c} ) + Δ {T}_{IB , c} + Δ {T}_{C , c} + Δ {T}_{R x S R S} , P - MP {R}_{c} , F - MP {R}_{c} ) \} ; and$$

the maximum value P_{CMAX_H,f,c} is equal to:

$${P}_{CMAX \_ H , f , c} = MIN \{ {P}_{EMAX , c} , {P}_{P o w e r C l a s s} - Δ {P}_{P o w e r C l a s s} \}$$

where F-MPR_{c} is maximum output power reduction due to energy shortage at the communication device 12.

In some embodiments, setting the maximum output power 18 comprises setting the maximum output power 18 to be within a maximum value and a minimum value, subject to a tolerance, wherein a magnitude of deviation tolerated below the minimum value is different than a magnitude of deviation tolerated above the maximum value.

In some embodiments, setting the maximum output power 18 comprises setting the maximum output power 18 such that a corresponding measured peak equivalent isotropic radiated power, EIRP, is within specified EIRP bounds. In other embodiments, setting the maximum output power 18 comprises setting the maximum output power 18 such that, alternatively or additionally, a corresponding measured total radiated power, TRP, is within specified TRP bounds.

In some embodiments, the metric is the amount E of energy stored in the energy storage 16. In other embodiments, the metric is a voltage associated with the energy storage 16. In some embodiments, the voltage is a voltage of the energy storage 16 in relation to a cutoff voltage. In some embodiments, the cutoff voltage is a voltage level below which the energy storage 16 is considered discharged.

In some embodiments, the maximum output power 18 is a maximum output power at an antenna connector of the communication device 12.

In some embodiments, the communication device 12 belongs to a class of communication devices capable of setting or reducing maximum output power 18 based on an amount E of energy stored in an energy storage 16 at the communication device 12. In some embodiments, the method further comprises reporting, to the communication network 10, that the communication device 12 belongs to the class of communication devices.

In some embodiments, said setting is performed as part of adapting, over time, the maximum output power 18 based on the metric as the amount E of energy stored in the energy storage 16 varies. In some embodiments, the method further comprises reporting, to the communication network 10, changes in the maximum output power 18.

In some embodiments, the method further comprises calculating a power headroom based on the maximum output power 18 and/or based on a maximum value that bounds the maximum output power 18. In some embodiments, the method further comprises reporting the power headroom to the communication network 10.

In some embodiments, the method further comprises reporting, to the communication network 10, the amount E of energy stored in the energy storage 16 of the communication device 12.

In some embodiments, the method further comprises transmitting, to the communication network 10, assistance information indicating one or more characteristics of the energy storage 16.

In some embodiments, the method further comprises reporting, to the communication network 10, impending depletion of the energy storage 16 to a point where no communication with the communication network 10 will be possible.

In some embodiments, the method further comprises reporting, to the communication network 10, resumption of communication with the communication network 10 after depletion of the energy storage 16 to a point where no communication with the communication network 10 was possible.

In some embodiments, the method further comprises receiving, from the communication network 10, barring information for a class of communication devices capable of setting or reducing maximum output power 18 based on an amount E of energy stored in an energy storage 16 at the communication device 10. In some embodiments, the barring information indicates whether the class is barred from access to the communication network 10, in which case the method further comprises accessing or refraining from accessing the communication network 10 depending on whether the communication device 12 is barred according to the barring information. In other embodiments, the barring information indicates that the class is allowed access to the communication network 10 provided that maximum output power 18 does not fall below a minimum value, in which case the method further comprises accessing the communication network 10 and setting the maximum output power 18 to not fall below the minimum value.

In some embodiments, setting the maximum output power 18 comprises setting the maximum output power 18 to be within a maximum value and a minimum value, subject to a tolerance, wherein the method further comprises evaluating a cell coverage level as a function of the minimum value. In some embodiments, said evaluating comprises evaluating a cell coverage level indicator Srxlex as Qrxlevmeas−(Qrxlevmin+Qrxlevminoffset)−Pcompensation−Qoffsettemp, where Pcompensation=max(PEMAX1−Pmaxflex,min, 0), where Pmaxflex,min is the minimum value.

In some embodiments, the method further comprises evaluating a cell coverage level as a function of the maximum output power 18. In some embodiments, said evaluating comprises evaluating a cell coverage level indicator Srxlex as Qrxlevmeas−(Qrxlevmin+Qrxlevminoffset)−Pcompensation−Qoffsettemp, where Pcompensation=max(PEMAX1−Pmaxflex, 0), where Pmaxflex is the maximum output power 18.

In some embodiments, the method further comprises receiving, from the communication network 10, control signaling indicating a random access configuration that is specific to and/or dedicated for a class of communication devices capable of setting or reducing maximum output power 18 based on an amount E of energy stored in an energy storage 16 at the communication device 12. In some embodiments, the random access configuration includes one or more dedicated random access preambles and/or one or more dedicated physical random access channel resources.

In some embodiments, the amount E of energy stored in the energy storage 16 has an impact on a maximum output power 18 of the communication device 12 and/or an impact on a power class of the communication device 12.

In some embodiments, the method further comprises transmitting, to the communication network, signaling 22 indicating that the communication device 12 is capable of setting or reducing the maximum output power 18 based on the amount E of energy stored in the energy storage 16 at the communication device 12.

Alternatively or additionally, FIG. 2B shows a method performed by a communication device 12 configured for use in a communication network 10. The method comprises calculating a power headroom based on a maximum output power 18, and/or based on a maximum value that bounds the maximum output power 18, that is set based on an amount E of energy stored in an energy storage 16 at the communication device 12 (Block 208). The method also comprises reporting the power headroom to the communication network 10 (Block 210).

Alternatively or additionally, FIG. 2C shows a method performed by a communication device 12 configured for use in a communication network 10.

The method in some embodiments comprises transmitting, to the communication network 10, signaling indicating changes in the maximum output power 18 (Block 206).

Alternatively or additionally, the method in FIG. 2C may comprise transmitting, to the communication network 10, signaling indicating the amount E of energy stored in the energy storage 16 of the communication device 12 (212).

Alternatively or additionally, the method in FIG. 2C may comprise transmitting, to the communication network 10, assistance information indicating one or more characteristics of an energy storage 16 at the communication device 12 (Block 214).

Alternatively or additionally, the method in FIG. 2C may comprise transmitting, to the communication network 10, signaling indicating impending depletion of an energy storage 16 of the communication device 12 to a point where no communication with the communication network 10 will be possible (Block 216) Alternatively or additionally, the method in FIG. 2C may comprise transmitting, to the communication network 10, signaling indicating resumption of communication with the communication network 10 after depletion of an energy storage 16 of the communication device 12 to a point where no communication with the communication network 10 was possible (Block 218).

Alternatively or additionally, FIG. 2D shows a method performed by a communication device 12 configured for use in a communication network 10. The method comprises receiving, from the communication network 10, barring information for a class of communication devices capable of setting or reducing maximum output power 18 based on an amount E of energy stored in an energy storage 16 at the communication device 12 (Block 220).

In some embodiments, the barring information 24 indicates whether the class is barred from access to the communication network 10. In these embodiments, the method may comprise accessing or refraining from accessing the communication network 10 depending on whether the communication device 12 is barred according to the barring information 24 (Block 222).

Alternatively or additionally, the barring information 24 may indicate that the class is allowed access to the communication network 10 provided that maximum output power 18 does not fall below a minimum value. In these embodiments, the method may comprise accessing the communication network 10 and setting the maximum output power 18 to not fall below the minimum value.

FIG. 2E shows a method performed by a communication device 12 configured for use in a communication network 10. The method comprises setting a maximum output power 18 to be within a maximum value and a minimum value, subject to a tolerance (Block 256). The method also comprises evaluating a cell coverage level as a function of the minimum value or the maximum output power 18 (Block 258).

FIG. 2F shows a method performed by a communication device 12 configured for use in a communication network 10. The method comprises receiving, from the communication network 10, control signaling indicating a random access configuration that is specific to and/or dedicated for a class of communication devices capable of setting or reducing maximum output power 18 based on an amount E of energy stored in an energy storage 16 at the communication device 12 (Block 260). The method also comprises performing random access to the communication network 10 according to the random access configuration (Block 262).

Note that any of the methods for the communication device 12 shown in FIGS. 2A-2F may be implemented independently of one another, or in combination with one another.

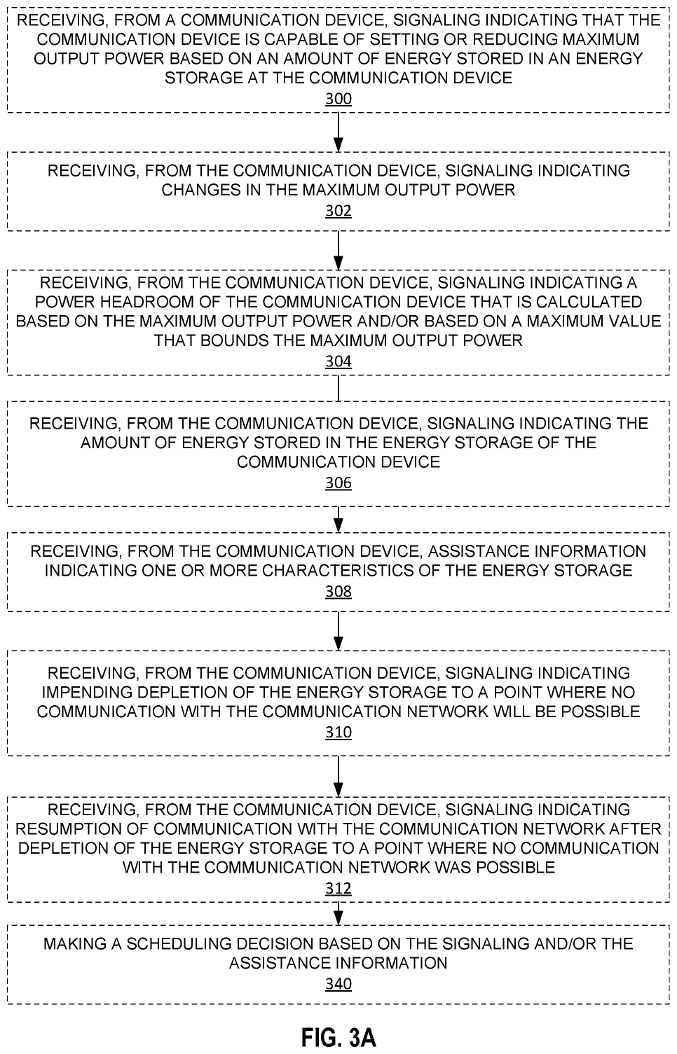

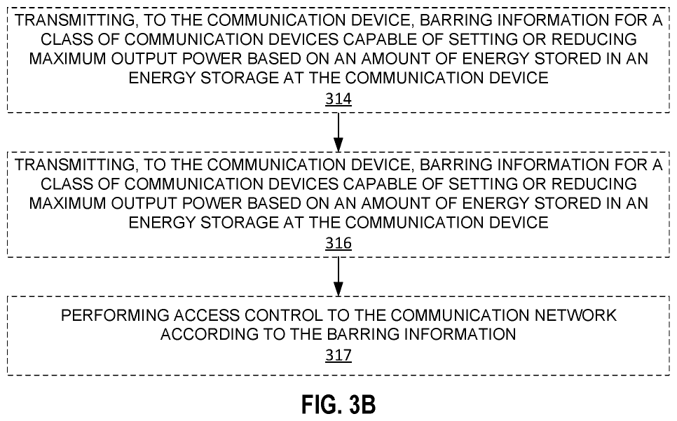

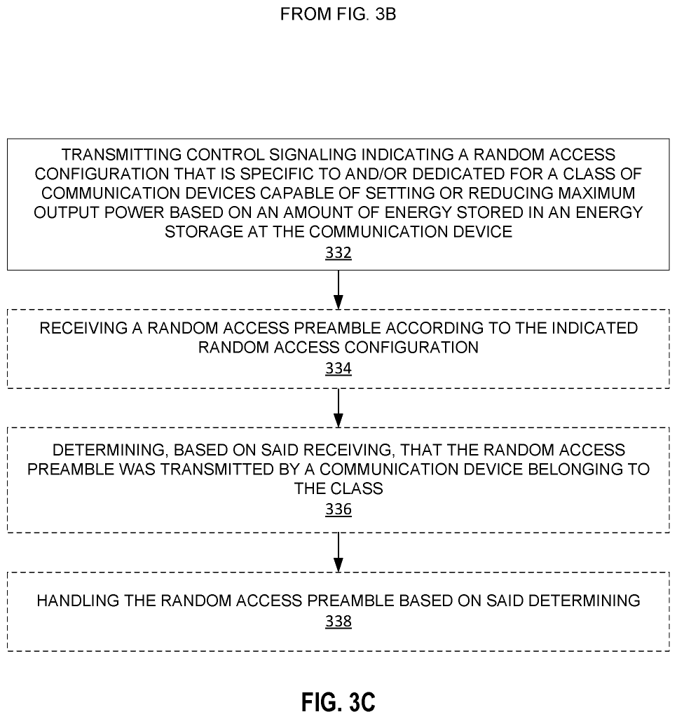

FIG. 3A shows a method performed by a network node 14 configured for use in a communication network 10. The method in some embodiments comprises receiving, from a communication device 12, signaling 22 indicating that the communication device 12 is capable of setting or reducing maximum output power 18 based on an amount E of energy stored in an energy storage 16 at the communication device 12 (Block 300). For example, in some embodiments, the signaling 22 indicates that the communication device 12 belongs to a class of communication devices capable of setting or reducing maximum output power 18 based on an amount E of energy stored in an energy storage 16 at the communication device 12.

Alternatively or additionally, the method may comprise receiving, from a communication device 12, signaling indicating changes in the maximum output power 18 (Block 302).

Alternatively or additionally, the method may comprise receiving, from a communication device 12, signaling indicating a power headroom of the communication device 12 and/or a maximum output power 18 of the communication device 12 (Block 304). In one embodiment, the power headroom is calculated based on the maximum output power 18 and/or based on a maximum value that bounds the maximum output power 18.

Alternatively or additionally, the method may comprise receiving, from a communication device 12, signaling indicating the amount E of energy stored in the energy storage 16 of the communication device 12 (Block 306).

Alternatively or additionally, the method may comprise receiving, from a communication device 12, assistance information indicating one or more characteristics of an energy storage 16 at the communication device 12 (Block 308).

Alternatively or additionally, the method may comprise receiving, from a communication device 12, signaling indicating impending depletion of an energy storage 16 of the communication device 12 to a point where no communication with the communication network 10 will be possible (Block 310). Additionally or alternatively, the method comprises receiving, from a communication device 12, signaling indicating resumption of communication with the communication network 10 after depletion of an energy storage 16 of the communication device 12 to a point where no communication with the communication network 10 was possible (Block 312).

Alternatively or additionally, the method may comprise making a scheduling decision 15 based on the signaling 22 and/or the assistance information (Block 340).

In some embodiments, for example the method comprises making the scheduling decision 15 based on the signaling 22. In some embodiments, the method further comprises determining, from the signaling 22, information about energy storage 16 at the communication device 12. In some embodiments, the scheduling decision 15 is made based on the determined information.

In other embodiments, as another example, the method comprises making the scheduling decision 15 based on the assistance information. In some embodiments, the method further comprises determining, from the assistance information, information about energy storage 16 at the communication device 12. In some embodiments, the scheduling decision 15 is made based on the determined information.

In some embodiments, the scheduling decision 15 includes a decision of a modulation and coding scheme, MCS, for an uplink transmission.

In some embodiments, the scheduling decision 15 includes a decision of an offset K2 between a downlink slot where a downlink control channel carrying downlink control information for uplink scheduling is received and an uplink slot where an uplink data transmission is to be sent on an uplink shared data channel.

In some embodiments, the scheduling decision 15 includes a decision of a frequency bandwidth of an uplink shared data channel for an uplink data transmission.

In some embodiments, the scheduling decision 15 includes a decision of a transport block size, TBS, of an uplink transmission.

In some embodiments, the scheduling decision 15 includes a decision of a type of information to transmit in an uplink transmission.

In some embodiments, the scheduling decision 15 includes a decision of whether and/or when a communication device 12 is to perform an uplink transmission.

In some embodiments, the scheduling decision 15 includes a decision of which communication device 12 is to perform an uplink transmission.

In some embodiments, the scheduling decision 15 includes a decision of a format of an uplink transmission.

In some embodiments, the information about energy storage 16 at the communication device 12 includes an energy harvesting rate of the communication device 12 relative to energy consumption of the communication device 12.

In some embodiments, the information about energy storage 16 at the communication device 12 includes an amount E of energy stored in the energy storage 16, a rate of energy consumption of the communication device 12, and/or whether the amount E of energy stored in the energy storage 16 is less than a threshold.

In some embodiments, the information about energy storage 16 at the communication device 12 includes a prediction of how a maximum output power 18 of the communication device 12 will change during a connection or signaling exchange with the communication network 10.

In some embodiments, the amount E of energy comprises the amount of harvested energy.

In some embodiments, the energy storage 16 of the communication device 12 is a super capacitor 16C.

In some embodiments, the signaling 22 indicates that the communication device 12 is capable of setting or reducing maximum output power 18 also based on an expected length of a connected with communication network 10.

In some embodiments, setting the maximum output power 18 comprises setting the maximum output power 18 to be within a maximum value and a minimum value. In some embodiments, the minimum value P_{CMAX_L,f,c} is equal to:

$${P}_{CMAX \_ L , f , c} = MIN \{ {P}_{EMAX , c} - Δ {T}_{C , c} , ( {P}_{P o w e r C l a s s} - Δ {P}_{P o w e r C l a s s} ) - MAX ( MAX ( MP {R}_{c} + Δ {MPR}_{c} , A - {MPR}_{c} ) + Δ {T}_{IB , c} + Δ {T}_{C , c} + Δ {T}_{R x S R S} , P - MP {R}_{c} ) , {P}_{maxflex , min} \} ;$$

and
the maximum value P_{CMAX_H,f,c} is equal to:

$${P}_{CMAX \_ H , f , c} = MIN \{ {P}_{EMAX , c} , {P}_{P o w e r C l a s s} - Δ {P}_{P o w e r C l a s s} , {P}_{maxflex , max} \} .$$

In other embodiments, the minimum value P_{CMAX_L,f,c} is equal to:

$${P}_{CMAX \_ L , f , c} = MIN \{ {P}_{EMAX , c} - Δ {T}_{C , c} , ( {P}_{P o w e r C l a s s} - Δ {P}_{P o w e r C l a s s} ) - MAX ( MAX ( MP {R}_{c} + Δ {MPR}_{c} , A - {MPR}_{c} ) + Δ {T}_{IB , c} + Δ {T}_{C , c} + Δ {T}_{R x S R S} , P - MP {R}_{c} , F - MP {R}_{c} ) \} ;$$

and
the maximum value P_{CMAX_H,f,c} is equal to:

$${P}_{CMAX \_ H , f , c} = MIN \{ {P}_{EMAX , c} , {P}_{P o w e r C l a s s} - Δ {P}_{P o w e r C l a s s} \}$$

where F-MPR_{c} is maximum output power reduction due to energy shortage at the communication device 12.

In some embodiments, setting the maximum output power 18 comprises setting the maximum output power 18 to be within the maximum value and the minimum value, subject to a tolerance.

In some embodiments, setting the maximum output power 18 comprises setting the maximum output power 18 to be within a maximum value and a minimum value, subject to a tolerance, wherein a magnitude of deviation tolerated below the minimum value is different than a magnitude of deviation tolerated above the maximum value.

In some embodiments, setting the maximum output power 18 comprises setting the maximum output power 18 such that a corresponding measured peak equivalent isotropic radiated power, EIRP, is within specified EIRP bounds. In other embodiments, setting the maximum output power 18 comprises setting the maximum output power 18 such that, alternatively or additionally, a corresponding measured total radiated power, TRP, is within specified TRP bounds.

In some embodiments, the metric is the amount E of energy stored in the energy storage 16.

In some embodiments, the metric is a voltage associated with the energy storage 16. In some embodiments, the voltage is a voltage of the energy storage 16 in relation to a cutoff voltage. In some embodiments, the cutoff voltage is a voltage level below which the energy storage 16 is considered discharged.

In some embodiments, the maximum output power 18 is a maximum output power at an antenna connector of the communication device 12.

In some embodiments, the signaling 22 indicates that the communication device 12 is capable of setting or reducing maximum output power 18 based on an amount E of energy stored in an energy storage 16 at the communication device 12 by indicating that the communication device 12 belongs to a class of communication devices capable of setting or reducing maximum output power 18 based on an amount E of energy stored in an energy storage 16 at the communication device 12.

In some embodiments, the signaling 22 indicates that the communication device 12 is capable of adapting, over time, the maximum output power 18 based on the metric as the amount E of energy stored in the energy storage 16 varies.

In some embodiments, the method further comprises receiving, from the communication device 12, signaling indicating changes in the maximum output power 18.

In some embodiments, the method further comprises receiving, from the communication device 12, a reporting of a power headroom of the communication device 12 that is calculated based on the maximum output power 18 and/or based on a maximum value that bounds the maximum output power 18.

In some embodiments, the method further comprises receiving, from the communication device 12, a report of the amount E of energy stored in the energy storage 16 of the communication device 12.

In some embodiments, the method further comprises receiving, from the communication device 12, assistance information indicating one or more characteristics of the energy storage 16.

In some embodiments, the method further comprises receiving, from the communication device 12, signaling indicating impending depletion of the energy storage 16 to a point where no communication with the communication network 10 will be possible.

In some embodiments, the method further comprises receiving, from the communication device 12, signaling indicating resumption of communication with the communication network 10 after depletion of the energy storage 16 to a point where no communication with the communication network 10 was possible.

In some embodiments, the method further comprises transmitting, to the communication device 12, barring information 24 for a class of communication devices capable of setting or reducing maximum output power 18 based on an amount E of energy stored in an energy storage 16 at the communication device 12, wherein the barring information 24 indicates whether the class is barred from access to the communication network 10.

In some embodiments, the method further comprises transmitting, to the communication device 12, barring information 24 for a class of communication devices capable of setting or reducing maximum output power 18 based on an amount E of energy stored in an energy storage 16 at the communication device 12, wherein the barring information 24 indicates that the class is allowed access to the communication network 10 provided that maximum output power 18 does not fall below a minimum value

In some embodiments, the method further comprises transmitting, to the communication device 12, control signaling indicating a random access configuration that is specific to and/or dedicated for a class of communication devices capable of setting or reducing maximum output power 18 based on an amount E of energy stored in an energy storage 16 at the communication device 12. In some embodiments, the random access configuration includes one or more dedicated random access preambles and/or one or more dedicated physical random access channel resources.

In some embodiments, the amount E of energy stored in the energy storage 16 has an impact on a maximum output power 18 of the communication device 12 and/or an impact on a power class of the communication device 12.

Alternatively or additionally, FIG. 3B shows a method performed by a network node 14 configured for use in a communication network 10. The method in some embodiments comprises transmitting barring information 24 for a class of communication devices capable of setting or reducing maximum output power 18 based on an amount E of energy stored in an energy storage 16 at the communication device 12 (Block 314). In some embodiments, the barring information 24 indicates whether the class is barred from access to the communication network 10.

Alternatively or additionally, the method may comprise transmitting barring information 24 for a class of communication devices capable of setting or reducing maximum output power 18 based on an amount E of energy stored in an energy storage 16 at the communication device 12. In some embodiments (Block 316), the barring information 24 indicates that the class is allowed access to the communication network 10 provided that maximum output power 18 does not fall below a minimum value.

In some embodiments, the barring information 24 indicates the minimum value.

In some embodiments, the method comprises performing access control to the communication network 10 according to the barring information 24 (Block 317).

FIG. 3C shows a method performed by a network node 14 configured for use in a communication network 10. The method in some embodiments comprises transmitting control signaling indicating a random access configuration that is specific to and/or dedicated for a class of communication devices capable of setting or reducing maximum output power 18 based on an amount E of energy stored in an energy storage 16 at the communication device 12 (Block 332).

In some embodiments, the method also comprises receiving a random access preamble according to the indicated random access configuration (Block 334). The method may then comprise determining, based on said receiving, that the random access preamble was transmitted by a communication device 12 belonging to the class (Block 336). In some embodiments, the method further comprises handling the random access preamble based on said determining (Block 338).

Additional embodiments herein include a method performed by a network node 14 configured for use in a communication network 10. The method comprises receiving, from a communication device 12, signaling indicating a power headroom of the communication device 12 and/or a maximum output power 18 of the communication device 12.

In some embodiments, the power headroom and/or the maximum output power 18 is calculated based on an amount E of energy stored in an energy storage 16 at the communication device 12.

Additional embodiments herein include a method performed by a network node 14 configured for use in a communication network 10. The method comprises receiving, from a communication device 12, assistance information indicating one or more characteristics of an energy storage 16 at the communication device 12.

Additional embodiments herein include a method performed by a network node 14 configured for use in a communication network 10. The method comprises receiving, from a communication device 12, signaling indicating impending depletion of an energy storage 16 of the communication device 12 to a point where no communication with the communication network 10 will be possible. In other embodiments, the method alternatively or additionally comprises receiving, from a communication device 12, signaling indicating resumption of communication with the communication network 10 after depletion of an energy storage 16 of the communication device 12 to a point where no communication with the communication network 10 was possible.

Note that any of the methods for the communication device 12 shown in FIGS. 3A-3C may be implemented independently of one another, or in combination with one another.

Embodiments herein also include corresponding apparatuses. Embodiments herein for instance include a communication device 12 configured to perform any of the steps of any of the embodiments described above for the wireless device.

Embodiments also include a communication device 12 comprising processing circuitry and power supply circuitry. The processing circuitry is configured to perform any of the steps of any of the embodiments described above for the communication device 12. The power supply circuitry is configured to supply power to the communication device 12.

Embodiments further include a communication device 12 comprising processing circuitry. The processing circuitry is configured to perform any of the steps of any of the embodiments described above for the communication device 12. In some embodiments, the communication device 12 further comprises communication circuitry.

Embodiments further include a communication device 12 comprising processing circuitry and memory. The memory contains instructions executable by the processing circuitry whereby the communication device 12 is configured to perform any of the steps of any of the embodiments described above for the communication device 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the communication device 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node 14 configured to perform any of the steps of any of the embodiments described above for the network node 14.

Embodiments also include a network node 14 comprising processing circuitry and power supply circuitry. The processing circuitry is configured to perform any of the steps of any of the embodiments described above for the network node 14. The power supply circuitry is configured to supply power to the network node 14.

Embodiments further include a network node 14 comprising processing circuitry. The processing circuitry is configured to perform any of the steps of any of the embodiments described above for the network node 14. In some embodiments, the network node 14 further comprises communication circuitry.

Embodiments further include a network node 14 comprising processing circuitry and memory. The memory contains instructions executable by the processing circuitry whereby the network node 14 is configured to perform any of the steps of any of the embodiments described above for the network node 14.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

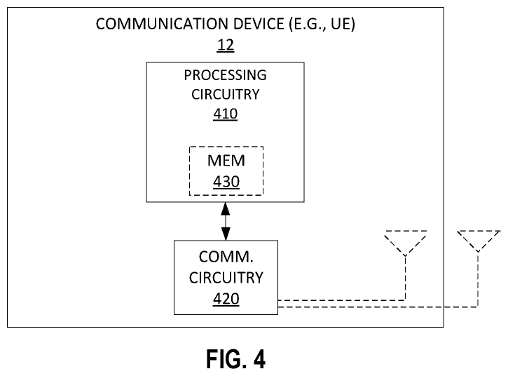

FIG. 4 for example illustrates a communication device 12 as implemented in accordance with one or more embodiments. As shown, the communication device 12 includes processing circuitry 410 and communication circuitry 420. The communication circuitry 420 (e.g., radio circuitry) is configured to transmit and/or receive information to and/or from one or more other nodes, e.g., via any communication technology. Such communication may occur via one or more antennas that are either internal or external to the communication device 12. The processing circuitry 410 is configured to perform processing described above, e.g., in FIGS. 2A, 2B, 2C, 2D, 2E, and/or 2F, such as by executing instructions stored in memory 430. The processing circuitry 410 in this regard may implement certain functional means, units, or modules.

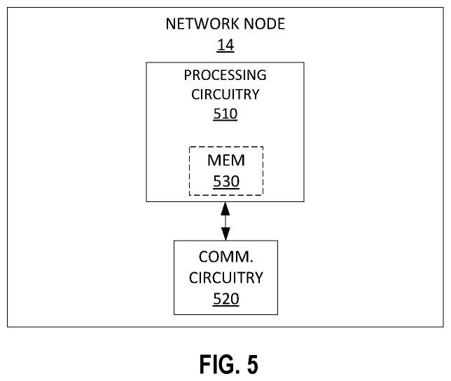

FIG. 5 illustrates a network node 14 as implemented in accordance with one or more embodiments. As shown, the network node 14 includes processing circuitry 510 and communication circuitry 520. The communication circuitry 520 is configured to transmit and/or receive information to and/or from one or more other nodes, e.g., via any communication technology. The processing circuitry 510 is configured to perform processing described above, e.g., in FIGS. 3A, 3B, and/or 3C, such as by executing instructions stored in memory 530. The processing circuitry 510 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

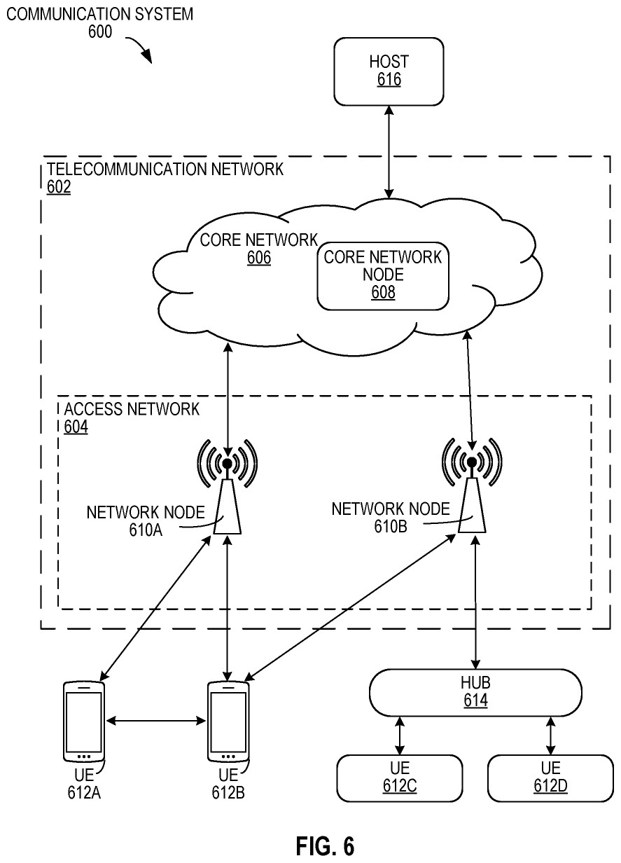

FIG. 6 shows an example of a communication system 600 in accordance with some embodiments.

In the example, the communication system 600 includes a telecommunication network 602 that includes an access network 604, such as a radio access network (RAN), and a core network 606, which includes one or more core network nodes 608. The access network 604 includes one or more access network nodes, such as network nodes 610a and 610b (one or more of which may be generally referred to as network nodes 610), or any other similar 3^{rd} Generation Partnership Project (3GPP) access node or non-3GPP access point. The network nodes 610 facilitate direct or indirect connection of user equipment (UE), such as by connecting UEs 612a, 612b, 612c, and 612d (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602, and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 602 is a cellular network that implements 3GPP standardized features. Accordingly, the telecommunications network 602 may support network slicing to provide different logical networks to different devices that are connected to the telecommunication network 602. For example, the telecommunications network 602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 614 communicates with the access network 604 to facilitate indirect communication between one or more UEs (e.g., UE 612c and/or 612d) and network nodes (e.g., network node 610b). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a VR headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular in if one or more of the UEs are low energy IoT devices.

The hub 614 may have a constant/persistent or intermittent connection to the network node 610b. The hub 614 may also allow for a different communication scheme and/or schedule between the hub 614 and UEs (e.g., UE 612c and/or 612d), and between the hub 614 and the core network 606. In other examples, the hub 614 is connected to the core network 606 and/or one or more UEs via a wired connection. Moreover, the hub 614 may be configured to connect to an M2M service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610b. In other embodiments, the hub 614 may be a non-dedicated hub—that is, a device which is capable of operating to route communications between the UEs and network node 610b, but which is additionally capable of operating as a communication start and/or end point for certain data channels.

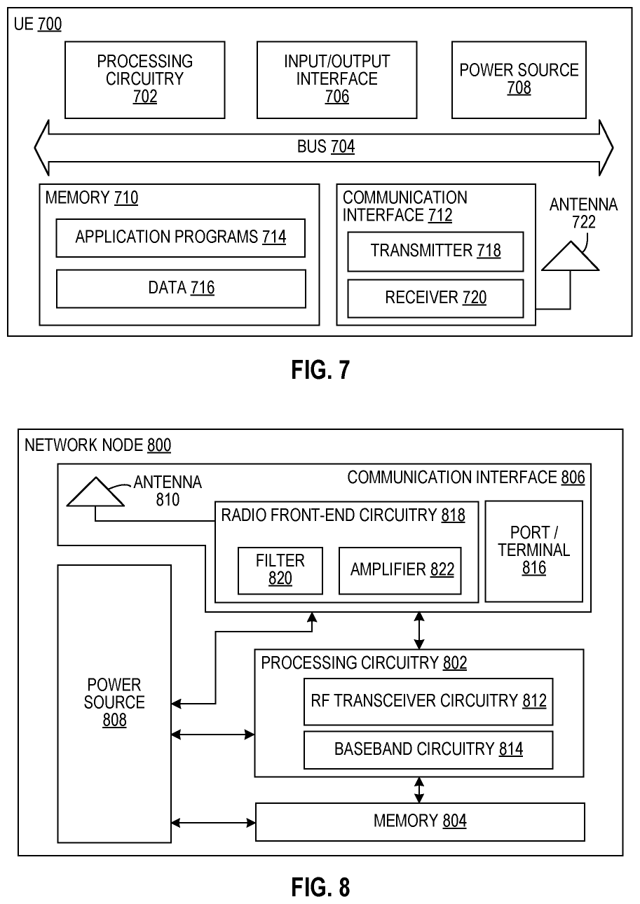

FIG. 7 shows a UE 700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3^{rd} Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V21), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, a memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 702 may include multiple central processing units (CPUs).

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging of the power source 708. Power circuitry may perform any formatting, converting, or other modification to the power from the power source 708 to make the power suitable for the respective components of the UE 700 to which power is supplied.

The memory 710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 710 may allow the UE 700 to access instructions, application programs and the like, stored on transitory or non-transitory memory media, to off-load data, or to upload data. An article of manufacture, such as one utilizing a communication system may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., antenna 722) and may share circuit components, software or firmware, or alternatively be implemented separately.

In the illustrated embodiment, communication functions of the communication interface 712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 700 shown in FIG. 7.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 8 shows a network node 800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes a processing circuitry 802, a memory 804, a communication interface 806, and a power source 808. The network node 800 may be composed of multiple physically separate components (e.g., a NodeB component and a RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 800 may be configured to support multiple radio access technologies (RATs). In such embodiments, some components may be duplicated (e.g., separate memory 804 for different RATs) and some components may be reused (e.g., a same antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 800.

The processing circuitry 802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 800 components, such as the memory 804, to provide network node 800 functionality.

In some embodiments, the processing circuitry 802 includes a system on a chip (SOC). In some embodiments, the processing circuitry 802 includes one or more of radio frequency (RF) transceiver circuitry 812 and baseband processing circuitry 814. In some embodiments, the radio frequency (RF) transceiver circuitry 812 and the baseband processing circuitry 814 may be on separate chips (or sets of chips), boards, or units, such as radio units and digital units. In alternative embodiments, part or all of RF transceiver circuitry 812 and baseband processing circuitry 814 may be on the same chip or set of chips, boards, or units.

The memory 804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and memory 804 is integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. Radio front-end circuitry 818 comprises filters 820 and amplifiers 822. The radio front-end circuitry 818 may be connected to an antenna 810 and processing circuitry 802. The radio front-end circuitry may be configured to condition signals communicated between antenna 810 and processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of filters 820 and/or amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface may comprise different components and/or different combinations of components.

In certain alternative embodiments, the network node 800 does not include separate radio front-end circuitry 818, instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes one or more ports or terminals 816, the radio front-end circuitry 818, and the RF transceiver circuitry 812, as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, communication interface 806, and/or the processing circuitry 802 may be configured to perform any receiving operations and/or certain obtaining operations described herein as being performed by the network node. Any information, data and/or signals may be received from a UE, another network node and/or any other network equipment. Similarly, the antenna 810, the communication interface 806, and/or the processing circuitry 802 may be configured to perform any transmitting operations described herein as being performed by the network node. Any information, data and/or signals may be transmitted to a UE, another network node and/or any other network equipment.

The power source 808 provides power to the various components of network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid, an electricity outlet) via an input circuitry or interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

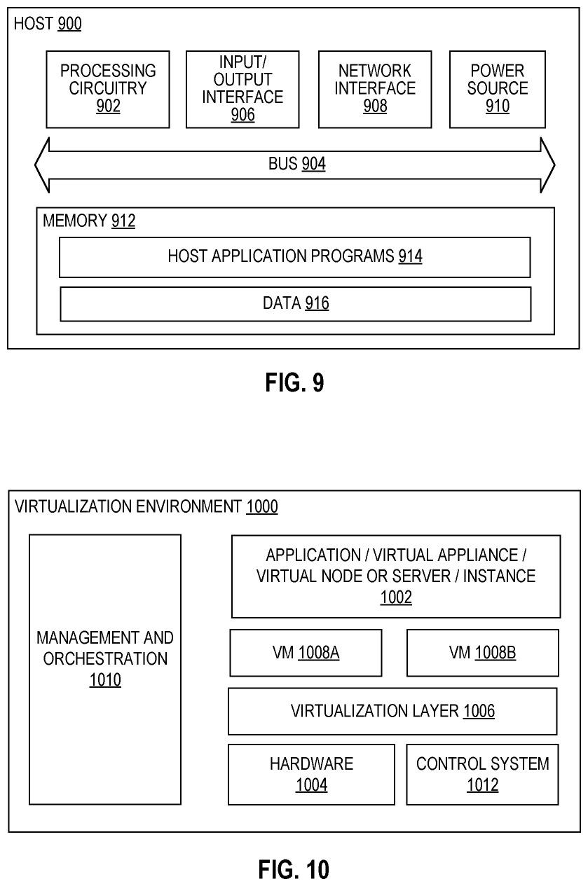

FIG. 9 is a block diagram of a host 900, which may be an embodiment of the host 616 of FIG. 6, in accordance with various aspects described herein. As used herein, the host 900 may be or comprise various combinations hardware and/or software, including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and a memory 912. Other components may be included in other embodiments. Features of these components may be substantially similar to those described with respect to the devices of previous figures, such as FIGS. 7 and 8, such that the descriptions thereof are generally applicable to the corresponding components of host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 914 may also provide for user authentication and licensing checks and may periodically report health, routes, and content availability to a central node, such as a device in or on the edge of a core network. Accordingly, the host 900 may select and/or indicate a different host for over-the-top services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 10 is a block diagram illustrating a virtualization environment 1000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or virtual machine monitors (VMMs)), provide VMs 1008a and 1008b (one or more of which may be generally referred to as VMs 1008), and/or perform any of the functions, features and/or benefits described in relation with some embodiments described herein. The virtualization layer 1006 may present a virtual operating platform that appears like networking hardware to the VMs 1008.

The VMs 1008 comprise virtual processing, virtual memory, virtual networking or interface and virtual storage, and may be run by a corresponding virtualization layer 1006. Different embodiments of the instance of a virtual appliance 1002 may be implemented on one or more of VMs 1008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1008 may be a software implementation of a physical machine that runs programs as if they were executing on a physical, non-virtualized machine. Each of the VMs 1008, and that part of hardware 1004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1008 on top of the hardware 1004 and corresponds to the application 1002.

Hardware 1004 may be implemented in a standalone network node with generic or specific components. Hardware 1004 may implement some functions via virtualization. Alternatively, hardware 1004 may be part of a larger cluster of hardware (e.g. such as in a data center or CPE) where many hardware nodes work together and are managed via management and orchestration 1010, which, among others, oversees lifecycle management of applications 1002. In some embodiments, hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1012 which may alternatively be used for communication between hardware nodes and radio units.

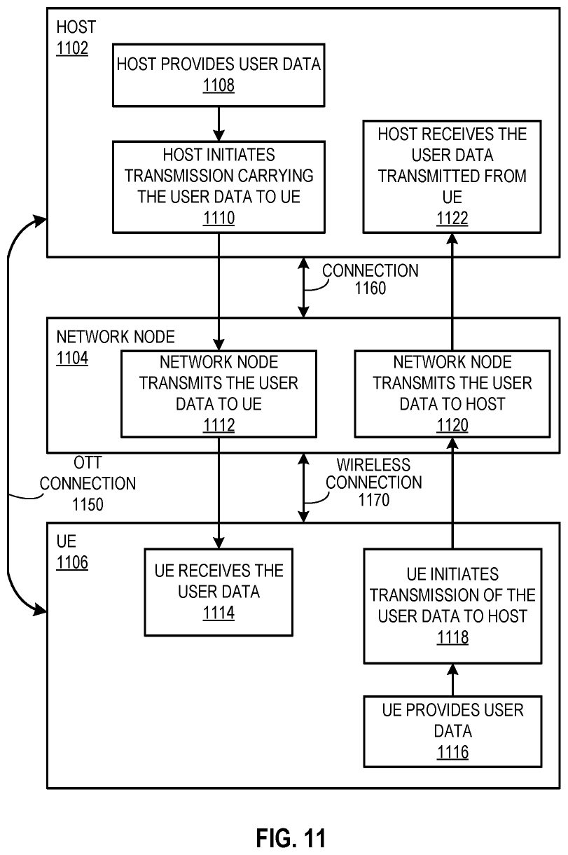

FIG. 11 shows a communication diagram of a host 1102 communicating via a network node 1104 with a UE 1106 over a partially wireless connection in accordance with some embodiments. Example implementations, in accordance with various embodiments, of the UE (such as a UE 612a of FIG. 6 and/or UE 700 of FIG. 7), network node (such as network node 610a of FIG. 6 and/or network node 800 of FIG. 8), and host (such as host 616 of FIG. 6 and/or host 900 of FIG. 9) discussed in the preceding paragraphs will now be described with reference to FIG. 11.

Like host 900, embodiments of host 1102 include hardware, such as a communication interface, processing circuitry, and memory. The host 1102 also includes software, which is stored in or accessible by the host 1102 and executable by the processing circuitry. The software includes a host application that may be operable to provide a service to a remote user, such as the UE 1106 connecting via an over-the-top (OTT) connection 1150 extending between the UE 1106 and host 1102. In providing the service to the remote user, a host application may provide user data which is transmitted using the OTT connection 1150.

The network node 1104 includes hardware enabling it to communicate with the host 1102 and UE 1106. The connection 1160 may be direct or pass through a core network (like core network 606 of FIG. 6) and/or one or more other intermediate networks, such as one or more public, private, or hosted networks. For example, an intermediate network may be a backbone network or the Internet.

The UE 1106 includes hardware and software, which is stored in or accessible by UE 1106 and executable by the UE's processing circuitry. The software includes a client application, such as a web browser or operator-specific “app” that may be operable to provide a service to a human or non-human user via UE 1106 with the support of the host 1102. In the host 1102, an executing host application may communicate with the executing client application via the OTT connection 1150 terminating at the UE 1106 and host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via a connection 1160 between the host 1102 and the network node 1104 and via a wireless connection 1170 between the network node 1104 and the UE 1106 to provide the connection between the host 1102 and the UE 1106. The connection 1160 and wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104, in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion (e.g., controlling traffic lights). As another example, the host 1102 may store surveillance video uploaded by a UE. As another example, the host 1102 may store or control access to media content such as video, audio, VR or AR which it can broadcast, multicast or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1150 between the host 1102 and UE 1106, in response to variations in the measurement results. The measurement procedure and/or the network functionality for reconfiguring the OTT connection may be implemented in software and hardware of the host 1102 and/or UE 1106. In some embodiments, sensors (not shown) may be deployed in or in association with other devices through which the OTT connection 1150 passes; the sensors may participate in the measurement procedure by supplying values of the monitored quantities exemplified above, or supplying values of other physical quantities from which software may compute or estimate the monitored quantities. The reconfiguring of the OTT connection 1150 may include message format, retransmission settings, preferred routing etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency and the like, by the host 1102. The measurements may be implemented in that software causes messages to be transmitted, in particular empty or ‘dummy’ messages, using the OTT connection 1150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Example embodiments of the techniques and apparatus described herein include, but are not limited to, the following enumerated examples:

### Group A Embodiments

A1. A method performed by a communication device configured for use in a communication network, the method comprising:
setting a maximum output power based on a metric reflecting an amount of energy stored in an energy storage of the communication device; and
performing one or more transmissions according to the maximum output power.
   A2. The method of embodiment A1, wherein the amount of energy comprises the amount of harvested energy.
   A3. The method of any of embodiments A1-A2, wherein the energy storage of the communication device is a super capacitor.
   A4. The method of any of embodiments A1-A3, wherein setting the maximum output power comprises setting the maximum output power also based on an expected length of a connection with communication network.
   A5. The method of any of embodiments A1-A4, wherein setting the maximum output power comprises setting the maximum output power to be within a maximum value and a minimum value.
   A6. The method of embodiment A5:
wherein the minimum value P_{CMAX_L,f,c} is equal to:

$${P}_{CMAX \_ L , f , c} = MIN \{ {P}_{EMAX , c} - Δ {T}_{C , c} , ( {P}_{P o w e r C l a s s} - Δ {P}_{P o w e r C l a s s} ) - MAX ( MAX ( MP {R}_{c} + Δ {MPR}_{c} , A - {MPR}_{c} ) + Δ {T}_{IB , c} + Δ {T}_{C , c} + Δ {T}_{R x S R S} , P - MP {R}_{c} ) , {P}_{maxflex , min} \} ;$$

and
wherein the maximum value P_{CMAX_H,f,c} is equal to:

$${P}_{CMAX \_ H , f , c} = MIN \{ {P}_{EMAX , c} , {P}_{P o w e r C l a s s} - Δ {P}_{P o w e r C l a s s} , {P}_{maxflex , max} \} .$$

A7. The method of embodiment A5:
wherein the minimum value P_{CMAX_L,f,c} is equal to:

$${P}_{CMAX \_ L , f , c} = MIN \{ {P}_{EMAX , c} - Δ {T}_{C , c} , ( {P}_{P o w e r C l a s s} - Δ {P}_{P o w e r C l a s s} ) - MAX ( MAX ( MP {R}_{c} + Δ {MPR}_{c} , A - {MPR}_{c} ) + Δ {T}_{IB , c} + Δ {T}_{C , c} + Δ {T}_{R x S R S} , P - MP {R}_{c} , F - MP {R}_{c} ) \} ;$$

and
wherein the maximum value P_{CMAX_H,f,c} is equal to:

$${P}_{CMAX \_ H , f , c} = MIN \{ {P}_{EMAX , c} , {P}_{P o w e r C l a s s} - Δ {P}_{P o w e r C l a s s} \}$$

where F-MPR_{c} is maximum output power reduction due to energy shortage at the communication device.
   A8. The method of any of embodiments A5-A7, wherein setting the maximum output power comprises setting the maximum output power to be within the maximum value and the minimum value, subject to a tolerance.
   A9. The method of any of embodiments A1-A4, wherein setting the maximum output power comprises setting the maximum output power to be within a maximum value and a minimum value, subject to a tolerance, wherein a magnitude of deviation tolerated below the minimum value is different than a magnitude of deviation tolerated above the maximum value.
   A10. The method of any of embodiments A1-A9, wherein setting the maximum output power comprises setting the maximum output power such that:
a corresponding measured peak equivalent isotropic radiated power, EIRP, is within specified EIRP bounds; and/or
a corresponding measured total radiated power, TRP, is within specified TRP bounds.
   A11. The method of any of embodiments A1-A10, wherein the metric is the amount of energy stored in the energy storage.
   A12. The method of any of embodiments A1-A10, wherein the metric is a voltage associated with the energy storage.
   A13. The method of embodiment A12, wherein the voltage is a voltage of the energy storage in relation to a cutoff voltage, wherein the cutoff voltage is a voltage level below which the energy storage is considered discharged.
   A14. The method of any of embodiments A1-A13, wherein the maximum output power is a maximum output power at an antenna connector of the communication device.
   A15. The method of any of embodiments A1-A14, wherein the communication device belongs to a class of communication devices capable of setting or reducing maximum output power based on an amount of energy stored in an energy storage at the communication device.
   A16. The method of embodiment A15, further comprising reporting, to the communication network, that the communication device belongs to the class of communication devices.
   A17. The method of any of embodiments A1-A16, wherein said setting is performed as part of adapting, over time, the maximum output power based on the metric as the amount of energy stored in the energy storage varies.
   A18. The method of embodiment A17, further comprising reporting, to the communication network, changes in the maximum output power.
   A19. The method of any of embodiments A1-A18, further comprising:
calculating a power headroom based on the maximum output power and/or based on a maximum value that bounds the maximum output power; and
reporting the power headroom to the communication network.
   A20. The method of any of embodiments A1-A19, further comprising reporting, to the communication network, the amount of energy stored in the energy storage of the communication device.
   A21. The method of any of embodiments A1-A20, further comprising transmitting, to the communication network, assistance information indicating one or more characteristics of the energy storage.
   A22. The method of any of embodiments A1-A21, further comprising reporting, to the communication network, impending depletion of the energy storage to a point where no communication with the communication network will be possible.
   A23. The method of any of embodiments A1-A22, further comprising reporting, to the communication network, resumption of communication with the communication network after depletion of the energy storage to a point where no communication with the communication network was possible.
   A24. The method of any of embodiments A1-A23, further comprising receiving, from the communication network, barring information for a class of communication devices capable of setting or reducing maximum output power based on an amount of energy stored in an energy storage at the communication device, wherein the barring information indicates whether the class is barred from access to the communication network.
   A25. The method of embodiment A24, further comprising accessing or refraining from accessing the communication network depending on whether the communication device is barred according to the barring information.
   A26. The method of any of embodiments A1-A25, further comprising receiving, from the communication network, barring information for a class of communication devices capable of setting or reducing maximum output power based on an amount of energy stored in an energy storage at the communication device, wherein the barring information indicates that the class is allowed access to the communication network provided that maximum output power does not fall below a minimum value.
   A27. The method of embodiment A26, further comprising accessing the communication network and setting the maximum output power to not fall below the minimum value.
   A28. The method of any of embodiments A1-A27, wherein setting the maximum output power comprises setting the maximum output power to be within a maximum value and a minimum value, subject to a tolerance, wherein the method further comprises evaluating a cell coverage level as a function of the minimum value.
   A29. The method of embodiment A28, wherein said evaluating comprises evaluating a cell coverage level indicator Srxlex as Qrxlevmeas−(Qrxlevmin+Qrxlevminoffset)−Pcompensation−Qoffsettemp, where Pcompensation=max(PEMAX1−Pmaxflex,min, 0), where Pmaxflex,min is the minimum value.
   A30. The method of any of embodiments A1-A27, further comprising evaluating a cell coverage level as a function of the maximum output power.
   A31. The method of embodiment A30, wherein said evaluating comprises evaluating a cell coverage level indicator Srxlex as Qrxlevmeas−(Qrxlevmin+Qrxlevminoffset)−Pcompensation−Qoffsettemp, where Pcompensation=max (PEMAX1−Pmaxflex, 0), where Pmaxflex is the maximum output power.
   A32. The method of any of embodiments A1-A31, further comprising receiving, from the communication network, control signaling indicating a random access configuration that is specific to and/or dedicated for a class of communication devices capable of setting or reducing maximum output power based on an amount of energy stored in an energy storage at the communication device.
   A33. The method of embodiment A32, wherein the random access configuration includes one or more dedicated random access preambles and/or one or more dedicated physical random access channel resources.
   A34. The method of any of embodiments A1-A33, wherein the amount of energy stored in the energy storage has an impact on a maximum output power of the communication device and/or an impact on a power class of the communication device.
   A35. The method of any of embodiments A1-A34, further comprising transmitting, to the communication network, signaling indicating that the communication device is capable of setting or reducing maximum output power based on an amount of energy stored in an energy storage at the communication device.
   A36. The method of embodiment A35, wherein the signaling indicates that the communication device belongs to a class of communication devices capable of setting or reducing maximum output power based on an amount of energy stored in an energy storage at the communication device.
   A37. A method performed by a communication device configured for use in a communication network, the method comprising:
reporting, to the communication network, that the communication device is capable of setting or reducing maximum output power based on an amount of energy stored in an energy storage at the communication device.
   A38. The method of embodiment A37, wherein said reporting comprises reporting, to the communication network, that the communication device belongs to a class of communication devices capable of setting or reducing maximum output power based on an amount of energy stored in an energy storage at the communication device.
   A39. A method performed by a communication device configured for use in a communication network, the method comprising:
calculating a power headroom based on a maximum output power, and/or based on a maximum value that bounds the maximum output power, that is set based on an amount of energy stored in an energy storage at the communication device; and
transmitting signaling indicating the power headroom to the communication network.
   A40. A method performed by a communication device configured for use in a communication network, the method comprising:
transmitting, to the communication network, assistance information indicating one or more characteristics of an energy storage at the communication device.
   A41. A method performed by a communication device configured for use in a communication network, the method comprising:
transmitting, to the communication network, signaling indicating impending depletion of an energy storage of the communication device to a point where no communication with the communication network will be possible; and/or
transmitting, to the communication network, signaling indicating resumption of communication with the communication network after depletion of an energy storage of the communication device to a point where no communication with the communication network was possible.
   A42. A method performed by a communication device configured for use in a communication network, the method comprising:
receiving, from the communication network, barring information for a class of communication devices capable of setting or reducing maximum output power based on an amount of energy stored in an energy storage at the communication device, wherein the barring information indicates whether the class is barred from access to the communication network; and
accessing or refraining from accessing the communication network depending on whether the communication device is barred according to the barring information.
   A43. A method performed by a communication device configured for use in a communication network, the method comprising:
receiving, from the communication network, barring information for a class of communication devices capable of setting or reducing maximum output power based on an amount of energy stored in an energy storage at the communication device, wherein the barring information indicates that the class is allowed access to the communication network provided that maximum output power does not fall below a minimum value; and
accessing the communication network; and
setting the maximum output power to not fall below the minimum value.
   A44. A method performed by a communication device configured for use in a communication network, the method comprising:
setting a maximum output power to be within a maximum value and a minimum value, subject to a tolerance; and
evaluating a cell coverage level as a function of the minimum value or the maximum output power.
   A45. A method performed by a communication device configured for use in a communication network, the method comprising:
receiving, from the communication network, control signaling indicating a random access configuration that is specific to and/or dedicated for a class of communication devices capable of setting or reducing maximum output power based on an amount of energy stored in an energy storage at the communication device; and
performing random access to the communication network according to the random access configuration.
   A46. The method of any of embodiments A37-A45, further comprising the limitations of any of embodiments A1-A36.

AA. The method of any of the previous embodiments, further comprising:
providing user data; and
forwarding the user data to a host computer via the transmission to a base station.

### Group B Embodiments

B1. A method performed by a network node configured for use in a communication network, the method comprising:
receiving, from a communication device, signaling indicating that the communication device is capable of setting or reducing maximum output power based on an amount of energy stored in an energy storage at the communication device.
   B2. The method of embodiment B1, wherein the amount of energy comprises the amount of harvested energy.
   B3. The method of any of embodiments B1-B2, wherein the energy storage of the communication device is a super capacitor.
   B4. The method of any of embodiments B1-B3, wherein the signaling indicates that the communication device is capable of setting or reducing maximum output power also based on an expected length of a connected with communication network.
   B5. The method of any of embodiments B1-B4, wherein setting the maximum output power comprises setting the maximum output power to be within a maximum value and a minimum value.
   B6. The method of embodiment B5:
wherein the minimum value P_{CMAX_L,f,c} is equal to:

$${P}_{CMAX \_ L , f , c} = MIN \{ {P}_{EMAX , c} - Δ {T}_{C , c} , ( {P}_{P o w e r C l a s s} - Δ {P}_{P o w e r C l a s s} ) - MAX ( MAX ( MP {R}_{c} + Δ {MPR}_{c} , A - {MPR}_{c} ) + Δ {T}_{IB , c} + Δ {T}_{C , c} + Δ {T}_{R x S R S} , P - MP {R}_{c} ) , {P}_{maxflex , min} \} ;$$

and
wherein the maximum value P_{CMAX_H,f,c} is equal to:

$${P}_{CMAX \_ H , f , c} = MIN \{ {P}_{EMAX , c} , {P}_{P o w e r C l a s s} - Δ {P}_{P o w e r C l a s s} , {P}_{maxflex , max} \} .$$

B7. The method of embodiment B5:
wherein the minimum value P_{CMAX_L,f,c} is equal to:

$${P}_{CMAX \_ L , f , c} = MIN \{ {P}_{EMAX , c} - Δ {T}_{C , c} , ( {P}_{P o w e r C l a s s} - Δ {P}_{P o w e r C l a s s} ) - MAX ( MAX ( MP {R}_{c} + Δ {MPR}_{c} , A - {MPR}_{c} ) + Δ {T}_{IB , c} + Δ {T}_{C , c} + Δ {T}_{R x S R S} , P - MP {R}_{c} , F - MP {R}_{c} ) \} ;$$

and
wherein the maximum value P_{CMAX_H,f,c} is equal to:

$${P}_{CMAX \_ H , f , c} = MIN \{ {P}_{EMAX , c} , {P}_{P o w e r C l a s s} - Δ {P}_{P o w e r C l a s s} \}$$

where F-MPR_{c} is maximum output power reduction due to energy shortage at the communication device.
   B8. The method of any of embodiments B5-B7, wherein setting the maximum output power comprises setting the maximum output power to be within the maximum value and the minimum value, subject to a tolerance.
   B9. The method of any of embodiments B1-B4, wherein setting the maximum output power comprises setting the maximum output power to be within a maximum value and a minimum value, subject to a tolerance, wherein a magnitude of deviation tolerated below the minimum value is different than a magnitude of deviation tolerated above the maximum value.
   B10. The method of any of embodiments B1-B9, wherein setting the maximum output power comprises setting the maximum output power such that:
a corresponding measured peak equivalent isotropic radiated power, EIRP, is within specified EIRP bounds; and/or
a corresponding measured total radiated power, TRP, is within specified TRP bounds.
   B11. The method of any of embodiments B1-B10, wherein the metric is the amount of energy stored in the energy storage.
   B12. The method of any of embodiments B1-B10, wherein the metric is a voltage associated with the energy storage.
   B13. The method of embodiment B12, wherein the voltage is a voltage of the energy storage in relation to a cutoff voltage, wherein the cutoff voltage is a voltage level below which the energy storage is considered discharged.
   B14. The method of any of embodiments B1-B13, wherein the maximum output power is a maximum output power at an antenna connector of the communication device.
   B15. The method of any of embodiments B1-B14, wherein the signaling indicates that the communication device is capable of setting or reducing maximum output power based on an amount of energy stored in an energy storage at the communication device by indicating that the communication device belongs to a class of communication devices capable of setting or reducing maximum output power based on an amount of energy stored in an energy storage at the communication device.

### B16. Reserved.

B17. The method of any of embodiments B1-B16, wherein the signaling indicates that the communication device is capable of adapting, over time, the maximum output power based on the metric as the amount of energy stored in the energy storage varies.
B18. The method of embodiment B17, further comprising receiving, from the communication device, signaling indicating changes in the maximum output power.
B19. The method of any of embodiments B1-B18, further comprising receiving, from the communication device, a reporting of a power headroom of the communication device that is calculated based on the maximum output power and/or based on a maximum value that bounds the maximum output power.
B20. The method of any of embodiments B1-B19, further comprising receiving, from the communication device, a report of the amount of energy stored in the energy storage of the communication device.
B21. The method of any of embodiments B1-B20, further comprising receiving, from the communication device, assistance information indicating one or more characteristics of the energy storage.
B22. The method of any of embodiments B1-B21, further comprising receiving, from the communication device, signaling indicating impending depletion of the energy storage to a point where no communication with the communication network will be possible.
B23. The method of any of embodiments B1-B22, further comprising receiving, from the communication device, signaling indicating resumption of communication with the communication network after depletion of the energy storage to a point where no communication with the communication network was possible.
B24. The method of any of embodiments B1-B23, further comprising transmitting, to the communication device, barring information for a class of communication devices capable of setting or reducing maximum output power based on an amount of energy stored in an energy storage at the communication device, wherein the barring information indicates whether the class is barred from access to the communication network.

### B25. Reserved.

B26. The method of any of embodiments B1-B25, further comprising transmitting, to the communication device, barring information for a class of communication devices capable of setting or reducing maximum output power based on an amount of energy stored in an energy storage at the communication device, wherein the barring information indicates that the class is allowed access to the communication network provided that maximum output power does not fall below a minimum value.

### B27-B31. Reserved.

B32. The method of any of embodiments B1-B31, further comprising transmitting, to the communication device, control signaling indicating a random access configuration that is specific to and/or dedicated for a class of communication devices capable of setting or reducing maximum output power based on an amount of energy stored in an energy storage at the communication device.
B33. The method of embodiment B32, wherein the random access configuration includes one or more dedicated random access preambles and/or one or more dedicated physical random access channel resources.
B34. The method of any of embodiments B1-B33, wherein the amount of energy stored in the energy storage has an impact on a maximum output power of the communication device and/or an impact on a power class of the communication device.

### B35-B37.

B38. A method performed by a network node configured for use in a communication network, the method comprising:
receiving, from a communication device, signaling indicating a power headroom of the communication device and/or a maximum output power of the communication device.
   B39. The method of embodiment B39, wherein the power headroom and/or the maximum output power is calculated based on an amount of energy stored in an energy storage at the communication device.
   B40. A method performed by a network node configured for use in a communication network, the method comprising:
receiving, from a communication device, assistance information indicating one or more characteristics of an energy storage at the communication device.
   B41. A method performed by a network node configured for use in a communication network, the method comprising receiving, from a communication device:
signaling indicating impending depletion of an energy storage of the communication device to a point where no communication with the communication network will be possible; and/or
signaling indicating resumption of communication with the communication network after depletion of an energy storage of the communication device to a point where no communication with the communication network was possible.
   B42. A method performed by a network node configured for use in a communication network, the method comprising:
transmitting barring information for a class of communication devices capable of setting or reducing maximum output power based on an amount of energy stored in an energy storage at the communication device, wherein the barring information indicates whether the class is barred from access to the communication network.
   B43. A method performed by a network node configured for use in a communication network, the method comprising:
transmitting barring information for a class of communication devices capable of setting or reducing maximum output power based on an amount of energy stored in an energy storage at the communication device, wherein the barring information indicates that the class is allowed access to the communication network provided that maximum output power does not fall below a minimum value.
   B44. The method of embodiment B43, wherein the barring information indicates the minimum value.
   B45. A method performed by a network node configured for use in a communication network, the method comprising:
transmitting control signaling indicating a random access configuration that is specific to and/or dedicated for a class of communication devices capable of setting or reducing maximum output power based on an amount of energy stored in an energy storage at the communication device.
   B46. The method of embodiment B45, further comprising:
receiving a random access preamble according to the indicated random access configuration;
determining, based on said receiving, that the random access preamble was transmitted by a communication device belonging to the class; and
handling the random access preamble based on said determining.
   B47. The method of any of embodiments B38-B46, further comprising the limitations of any of embodiments B1-B39.
   B48. The method of any of embodiments B1-B37 and B38-B41, further comprising making a scheduling decision based on the signaling.
   B49. The method of embodiment B48, further comprising determining, from the signaling, information about energy storage at the communication device, wherein the scheduling decision is made based on the determined information.
   B50. The method of embodiment B41, further comprising making a scheduling decision based on the assistance information.
   B51. The method of embodiment B50, further comprising determining, from the assistance information, information about energy storage at the communication device, wherein the scheduling decision is made based on the determined information.
   B52. The method of embodiment B46, wherein said handling comprises making a scheduling decision.
   B53. The method of any of embodiments B47-B52, wherein the scheduling decision includes a decision of a modulation and coding scheme, MCS, for an uplink transmission.
   B54. The method of any of embodiments B47-B53, wherein the scheduling decision includes a decision of an offset K2 between a downlink slot where a downlink control channel carrying downlink control information for uplink scheduling is received and an uplink slot where an uplink data transmission is to be sent on an uplink shared data channel.
   B55. The method of any of embodiments B47-B54, wherein the scheduling decision includes a decision of a frequency bandwidth of an uplink shared data channel for an uplink data transmission.
   B56. The method of any of embodiments B47-B55, wherein the scheduling decision includes a decision of a transport block size, TBS, of an uplink transmission.
   B57. The method of any of embodiments B47-B55, wherein the scheduling decision includes a decision of a type of information to transmit in an uplink transmission.
   B58. The method of any of embodiments B47-B55, wherein the scheduling decision includes a decision of whether and/or when a communication device is to perform an uplink transmission.
   B59. The method of any of embodiments B47-B55, wherein the scheduling decision includes a decision of which communication device is to perform an uplink transmission.
   B60. The method of any of embodiments B47-B55, wherein the scheduling decision includes a decision of a format of an uplink transmission.
   B61. The method of any of embodiments B49 and B51, wherein the information about energy storage at the communication device includes an energy harvesting rate of the communication device relative to energy consumption of the communication device.
   B62. The method of any of embodiments B49, B51 and B61, wherein the information about energy storage at the communication device includes an amount of energy stored in the energy storage, a rate of energy consumption of the communication device, and/or whether the amount of energy stored in the energy storage is less than a threshold.
   B63. The method of any of embodiments B49, B51 and B61-B62, wherein the information about energy storage at the communication device includes a prediction of how a maximum output power of the communication device will change during a connection or signaling exchange with the communication network.
   BB. The method of any of the previous embodiments, further comprising:
obtaining user data; and
forwarding the user data to a host computer or a wireless communication device.

### Group C Embodiments

C1. A communication device configured to perform any of the steps of any of the Group A embodiments.
C2. A communication device comprising processing circuitry configured to perform any of the steps of any of the Group A embodiments.
C3. A communication device comprising:
communication circuitry; and
processing circuitry configured to perform any of the steps of any of the Group A embodiments.
   C4. A communication device comprising:
processing circuitry configured to perform any of the steps of any of the Group A embodiments; and
power supply circuitry configured to supply power to the communication device.
   C5. A communication device comprising:
processing circuitry and memory, the memory containing instructions executable by the processing circuitry whereby the communication device is configured to perform any of the steps of any of the Group A embodiments.
   C6. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.
   C7. A computer program comprising instructions which, when executed by at least one processor of a communication device, causes the communication device to carry out the steps of any of the Group A embodiments.
   C8. A carrier containing the computer program of embodiment C7, wherein the carrier is one of an electronic signal, optical signal, radio signal, or computer readable storage medium.
   C9. A network node configured to perform any of the steps of any of the Group B embodiments.
   C10. A network node comprising processing circuitry configured to perform any of the steps of any of the Group B embodiments.
   C11. A network node comprising:
communication circuitry; and
processing circuitry configured to perform any of the steps of any of the Group B embodiments.
   C12. A network node comprising:
processing circuitry configured to perform any of the steps of any of the Group B embodiments;
power supply circuitry configured to supply power to the network node.
   C13. A network node comprising:
processing circuitry and memory, the memory containing instructions executable by the processing circuitry whereby the network node is configured to perform any of the steps of any of the Group B embodiments.
   C14. The network node of any of embodiments C9-C13, wherein the network node is a base station.
   C15. A computer program comprising instructions which, when executed by at least one processor of a network node, causes the network node to carry out the steps of any of the Group B embodiments.
   C16. The computer program of embodiment C14, wherein the network node is a base station.
   C17. A carrier containing the computer program of any of embodiments C15-C16, wherein the carrier is one of an electronic signal, optical signal, radio signal, or computer readable storage medium.

### Group D Embodiments

D1. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.
   D2. The communication system of the previous embodiment further including the base station.
   D3. The communication system of the previous 2 embodiments, further including the UE, wherein the UE is configured to communicate with the base station.
   D4. The communication system of the previous 3 embodiments, wherein:
the processing circuitry of the host computer is configured to execute a host application, thereby providing the user data; and
the UE comprises processing circuitry configured to execute a client application associated with the host application.
   D5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.
   D6. The method of the previous embodiment, further comprising, at the base station, transmitting the user data.
   D7. The method of the previous 2 embodiments, wherein the user data is provided at the host computer by executing a host application, the method further comprising, at the UE, executing a client application associated with the host application.
   D8. A user equipment (UE) configured to communicate with a base station, the UE comprising a radio interface and processing circuitry configured to perform any of the previous 3 embodiments.
   D9. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.
   D10. The communication system of the previous embodiment, wherein the cellular network further includes a base station configured to communicate with the UE.
   D11. The communication system of the previous 2 embodiments, wherein:
the processing circuitry of the host computer is configured to execute a host application, thereby providing the user data; and
the UE's processing circuitry is configured to execute a client application associated with the host application.
   D12. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.
   D13. The method of the previous embodiment, further comprising at the UE, receiving the user data from the base station.
   D14. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.
   D15. The communication system of the previous embodiment, further including the UE.
   D16. The communication system of the previous 2 embodiments, further including the base station, wherein the base station comprises a radio interface configured to communicate with the UE and a communication interface configured to forward to the host computer the user data carried by a transmission from the UE to the base station.
   D17. The communication system of the previous 3 embodiments, wherein:
the processing circuitry of the host computer is configured to execute a host application; and
the UE's processing circuitry is configured to execute a client application associated with the host application, thereby providing the user data.
   D18. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.
   D19. A method implemented in a communication system including a host computer, a base station and a user equipment (UE), the method comprising:
at the host computer, receiving user data transmitted to the base station from the UE, wherein the UE performs any of the steps of any of the Group A embodiments.
   D20. The method of the previous embodiment, further comprising, at the UE, providing the user data to the base station.
   D21. The method of the previous 2 embodiments, further comprising:
at the UE, executing a client application, thereby providing the user data to be transmitted; and
at the host computer, executing a host application associated with the client application.
   D22. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.
   D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
   D24. The communication system of the previous embodiment further including the base station.
   D25. The communication system of the previous 2 embodiments, further including the UE, wherein the UE is configured to communicate with the base station.
   D26. The communication system of the previous 3 embodiments, wherein:
the processing circuitry of the host computer is configured to execute a host application;
the UE is configured to execute a client application associated with the host application, thereby providing the user data to be received by the host computer.
   D27. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.
   D28. The method of the previous embodiment, further comprising at the base station, receiving the user data from the UE.
   D29. The method of the previous 2 embodiments, further comprising at the base station, initiating a transmission of the received user data to the host computer.

### REFERENCES

1. S1-214135, Motivation on support Energy Harvesting enabled Communication services in 5GS, Oppo
2. “Nowi Powered Energy Autonomous Nordic Thingy: 91 Platform”, Nordic semiconductor
3. TS 38.101-1 version 16.0.0
4. TS 38.321 version 16.0.0
5. TS 38.304 version 16.0.0
6. TS 38.101-2 version 16.0.0

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).

| | |
|---|---|
| 1x RTT | CDMA2000 1x Radio Transmission Technology |
| 3GPP | 3rd Generation Partnership Project |
| 5G | 5th Generation |
| 6G | 6^{th} Generation |
| ABS | Almost Blank Subframe |
| ARQ | Automatic Repeat Request |
| AWGN | Additive White Gaussian Noise |
| BCCH | Broadcast Control Channel |
| BCH | Broadcast Channel |
| CA | Carrier Aggregation |
| CC | Carrier Component |
| CCCH SDU | Common Control Channel SDU |
| CDMA | Code Division Multiplexing Access |
| CGI | Cell Global Identifier |
| CIR | Channel Impulse Response |
| CP | Cyclic Prefix |
| CPICH | Common Pilot Channel |
| CPICH | Ec/No CPICH Received energy per chip divided by the |
| | power density in the band |
| CQI | Channel Quality information |
| C-RNTI | Cell RNTI |
| CSI | Channel State Information |
| DCCH | Dedicated Control Channel |
| DL | Downlink |
| DM | Demodulation |
| DMRS | Demodulation Reference Signal |
| DRX | Discontinuous Reception |
| DTX | Discontinuous Transmission |
| DTCH | Dedicated Traffic Channel |
| DUT | Device Under Test |
| E-CID | Enhanced Cell-ID (positioning method) |
| eMBMS | evolved Multimedia Broadcast Multicast Services |
| E-SMLC | Evolved-Serving Mobile Location Centre |
| ECGI | Evolved CGI |
| eNB | E-UTRAN NodeB |
| ePDCCH | Enhanced Physical Downlink Control Channel |
| E-SMLC | Evolved Serving Mobile Location Center |
| E-UTRA | Evolved UTRA |
| E-UTRAN | Evolved UTRAN |
| FDD | Frequency Division Duplex |
| FFS | For Further Study |
| gNB | Base station in NR |
| GNSS | Global Navigation Satellite System |
| HARQ | Hybrid Automatic Repeat Request |
| HO | Handover |
| HSPA | High Speed Packet Access |
| HRPD | High Rate Packet Data |
| LOS | Line of Sight |
| LPP | LTE Positioning Protocol |
| LTE | Long-Term Evolution |
| MAC | Medium Access Control |
| MAC | Message Authentication Code |
| MBSFN | Multimedia Broadcast multicast service Single |
| | Frequency Network |
| MBSFN ABS | MBSFN Almost Blank Subframe |
| MDT | Minimization of Drive Tests |
| MIB | Master Information Block |
| MME | Mobility Management Entity |
| MSC | Mobile Switching Center |
| NPDCCH | Narrowband Physical Downlink Control Channel |
| NR | New Radio |
| OCNG | OFDMA Channel Noise Generator |
| OFDM | Orthogonal Frequency Division Multiplexing |
| OFDMA | Orthogonal Frequency Division Multiple Access |
| OSS | Operations Support System |
| OTDOA | Observed Time Difference of Arrival |
| O&M | Operation and Maintenance |
| PBCH | Physical Broadcast Channel |
| P-CCPCH | Primary Common Control Physical Channel |
| PCell | Primary Cell |
| PCFICH | Physical Control Format Indicator Channel |
| PDCCH | Physical Downlink Control Channel |
| PDCP | Packet Data Convergence Protocol |
| PDP | Power Delay Profile |
| PDSCH | Physical Downlink Shared Channel |
| PGW | Packet Gateway |
| PHICH | Physical Hybrid-ARQ Indicator Channel |
| PLMN | Public Land Mobile Network |
| PMI | Precoder Matrix Indicator |
| PRACH | Physical Random Access Channel |
| PRS | Positioning Reference Signal |
| PSS | Primary Synchronization Signal |
| PUCCH | Physical Uplink Control Channel |
| PUSCH | Physical Uplink Shared Channel |
| RACH | Random Access Channel |
| QAM | Quadrature Amplitude Modulation |
| RAN | Radio Access Network |
| RAT | Radio Access Technology |
| RLC | Radio Link Control |
| RLM | Radio Link Management |
| RNC | Radio Network Controller |
| RNTI | Radio Network Temporary Identifier |
| RRC | Radio Resource Control |
| RRM | Radio Resource Management |
| RS | Reference Signal |
| RSCP | Received Signal Code Power |
| RSRP | Reference Symbol Received Power OR |
| | Reference Signal Received Power |
| RSRQ | Reference Signal Received Quality OR |
| | Reference Symbol Received Quality |
| RSSI | Received Signal Strength Indicator |
| RSTD | Reference Signal Time Difference |
| SCH | Synchronization Channel |
| SCell | Secondary Cell |
| SDAP | Service Data Adaptation Protocol |
| SDU | Service Data Unit |
| SFN | System Frame Number |
| SGW | Serving Gateway |
| SI | System Information |
| SIB | System Information Block |
| SNR | Signal to Noise Ratio |
| SON | Self Optimized Network |
| SS | Synchronization Signal |
| SSS | Secondary Synchronization Signal |
| TDD | Time Division Duplex |
| TDOA | Time Difference of Arrival |
| TOA | Time of Arrival |
| TSS | Tertiary Synchronization Signal |
| TTI | Transmission Time Interval |
| UE | User Equipment |
| UL | Uplink |
| USIM | Universal Subscriber Identity Module |
| UTDOA | Uplink Time Difference of Arrival |
| WCDMA | Wide CDMA |
| WLAN | Wide Local Area Network |

1. A method performed by a communication device configured for use in a communication network, the method comprising:
setting a maximum output power based on a metric reflecting an amount of energy stored in an energy storage of the communication device;
performing one or more transmissions according to the maximum output power;
transmitting, to the communication network, signaling indicating that the communication device is capable of setting or reducing the maximum output power based on the amount of energy stored in the energy storage at the communication device;
calculating a power headroom based on one or both the maximum output power and a maximum value that bounds the maximum output power; and
reporting the power headroom to the communication network.

2. The method of claim 1, wherein one or both the amount of energy comprises amount of harvested energy and the energy storage of the communication device is a super capacitor.

3. The method of claim 1, wherein setting the maximum output power comprises, during a connection with the communication network, setting the maximum output power also based on an expected length of the connection with communication network.

4. The method of claim 3, wherein setting the maximum output power comprises, during the connection with the communication network, reducing the maximum output power as needed to maintain the connection with the communication network for at least the expected length.

5. The method of claim 1, wherein setting the maximum output power comprises setting the maximum output power to be within a maximum value and a minimum value, subject to a tolerance.

6. The method of claim 5, wherein a magnitude of deviation tolerated below the minimum value is different than a magnitude of deviation tolerated above the maximum value.

7. The method of claim 1, wherein the maximum output power is a maximum output power at an antenna connector of the communication device, and wherein setting the maximum output power comprises setting the maximum output power such that one or both:
a corresponding measured peak equivalent isotropic radiated power, EIRP, is within specified EIRP bounds; and
a corresponding measured total radiated power, TRP, is within specified TRP bounds.

8. The method of claim 1, wherein the metric is:
the amount of energy stored in the energy storage; or
a voltage associated with the energy storage, wherein the voltage is a voltage of the energy storage in relation to a cutoff voltage, wherein the cutoff voltage is a voltage level below which the energy storage is considered discharged.

9. The method of claim 1, wherein the communication device belongs to a class of communication device s capable of setting or reducing maximum output power based on an amount of energy stored in an energy storage at the communication device, and wherein the method further comprises reporting, to the communication network, that the communication device belongs to the class of communication device.

10.-12. (canceled)

13. A method performed by a network node configured for use in a communication network, the method comprising:
receiving, from a communication device, signaling indicating that the communication device is capable of setting or reducing maximum output power based on an amount of energy stored in an energy storage at the communication device; and
receiving, from the communication device, a reporting of a power headroom of the communication device that is calculated based on one or both the maximum output power and a maximum value that bounds the maximum output power.

14. The method of claim 13, wherein one or both the amount of energy comprises the amount of harvested energy and the energy storage of the communication device is a super capacitor.

15. The method of claim 13, wherein the signaling indicates that the communication device is capable of setting or reducing maximum output power also based on an expected length of a connected with communication network.

16. The method of claim 13, wherein the signaling indicates that the communication device is capable of setting the maximum output power to be within a maximum value and a minimum value, subject to a tolerance, based on the amount of energy stored in the energy storage at the communication device.

17. The method of claim 16, wherein a magnitude of deviation tolerated below the minimum value is different than a magnitude of deviation tolerated above the maximum value.

18. The method of claim 13, wherein the maximum output power is a maximum output power at an antenna connector of the communication device, and wherein the signaling indicates that the communication device is capable of setting the maximum output power such that one or both:
a corresponding measured peak equivalent isotropic radiated power, EIRP, is within specified EIRP bounds; and
a corresponding measured total radiated power, TRP, is within specified TRP bounds.

19.-22. (canceled)

23. The method of claim 13, further comprising making a scheduling decision based on the signaling.

24. The method of claim 23, further comprising determining, from the signaling, information about energy storage at the communication device, wherein the scheduling decision is made based on the determined information, wherein the scheduling decision includes one or more out of:
a decision of a modulation and coding scheme, MCS, for an uplink transmission;
a decision of an offset K2 between a downlink slot where a downlink control channel carrying downlink control information for uplink scheduling is received and an uplink slot where an uplink data transmission is to be sent on an uplink shared data channel;
a decision of a frequency bandwidth of an uplink shared data channel for an uplink data transmission;
a decision of a transport block size, TBS, of an uplink transmission;
a decision of a type of information to transmit in an uplink transmission;
a decision of one or both whether and when a communication device is to perform an uplink transmission;
a decision of which communication device is to perform an uplink transmission; and
a decision of a format of an uplink transmission.

25. The method of claim 24, wherein the information about energy storage at the communication device includes one or more out of:
an energy harvesting rate of the communication device relative to energy consumption of the communication device;
an amount of energy stored in the energy storage;
a rate of energy consumption of the communication device;
whether the amount of energy stored in the energy storage is less than a threshold; and
a prediction of how a maximum output power of the communication device will change during a connection or signaling exchange with the communication network.

26.-32. (canceled)

33. A communication device configured for use in a communication network, the communication device comprising:
communication circuitry; and
processing circuitry configured to:
set a maximum output power based on a metric reflecting an amount of energy stored in an energy storage of the communication device;
perform one or more transmissions according to the maximum output power;
transmit, to the communication network, signaling indicating that the communication device is capable of setting or reducing the maximum output power based on the amount of energy stored in the energy storage at the communication device;
calculate a power headroom based on one or both of the maximum output power and a maximum value that bounds the maximum output power; and
report the power headroom to the communication network.

34. (canceled)

35. A network node configured for use in a communication network, the network node comprising:
communication circuitry; and
processing circuitry configured to receive, from a communication device, signaling indicating that the communication device is capable of setting or reducing maximum output power based on an amount of energy stored in an energy storage at the communication device; and
receive, from the communication device, a reporting of a power headroom of the communication device that is calculated based on one or both of the maximum output power and a maximum value that bounds the maximum output power.

36. (canceled)
